(19) United States
(12) Patent Application Publication
(10) Pub. No.: US 2026/0220581 A1
(43) Pub. Date: Jul. 30, 2026

(54) EXTRACTING AND UTILIZING PROVIDER PERFORMANCE METRICS TO GENERATE DIGITAL THIRD-PARTY REFERRAL DOCUMENTS AND TARGETED OPPORTUNITY RECOMMENDATIONS

(71) Applicant: Lyft, Inc., San Francisco, CA (US)

(72) Inventors: John David Risher, San Francisco, CA (US); Benjamin Thomas Dye, New York, NY (US); Jeana Choi, Brooklyn, NY (US); Rohan Varshney, New York, NY (US); Indigo Joanna Starr, Boulder, CO (US); Maheep Myneni, New York, NY (US); Yunhao Qing, Sunnyvale, CA (US); Ju Hye Hwoang, Seattle, WA (US); Timothy Kyle Downey, Issaquah, WA (US)

(21) Appl. No.: 19/040,587

(22) Filed: Jan. 29, 2025

(51) Int. Cl. G06Q 10/0639; G06Q 50/47

(52) U.S. Cl. CPC G06Q 10/0639; G06Q 50/47

(57) ABSTRACT

The present disclosure relates to systems, non-transitory computer-readable media, and methods that utilize a generative model to generate customized digital third-party referral documents as well as refer providers to targeted opportunities based on characteristics of the providers inferred from the provider device performance metrics. For example, in one or more implementations, the disclosed systems extract provider device performance metrics associated with transportation requests fulfilled by the provider device. In addition, the disclosed systems can utilize a generative model to generate a customized text summary reflecting characteristics of a provider inferred from the provider device performance metrics. In some embodiments, the disclosed systems generate a third-party referral document comprising the customized text summary. Furthermore, the disclosed systems can transmit the digital third-party referral document to a client device for display via a user interface of the client device.

### BACKGROUND

In recent years, significant advancements have been made in conventional transportation systems that utilize mobile devices to coordinate across computer networks. The widespread use of web and mobile applications has enabled ride-sharing platforms to efficiently match provider devices with requestor devices by coordinating across these networks. Moreover, conventional transportation systems can also utilize geographic data to enable real-time tracking of pick-ups, transportation, and drop-offs through digital transmissions across computer networks. While these advancements have enhanced the capabilities of transportation systems, providers within conventional transportation systems have often established a pattern or history of performance but cannot leverage or illustrate that performance with regard to other opportunities. Indeed, conventional platforms continue to exhibit a number of deficiencies with regard to flexibility, accuracy, data security, and operational efficiency, particularly with regard to intelligently utilizing dynamic metrics extracted from interactions across computing devices for additional generative tasks.

These, along with additional problems and issues, exist with conventional digital systems.

### SUMMARY

This disclosure describes one or more embodiments of methods, non-transitory computer-readable media, and systems that utilize a generative model to generate customized digital third-party referral documents as well as refer providers to targeted opportunities based on characteristics of the providers inferred from provider device performance metrics. For example, in one or more implementations, the disclosed systems collect and build a complex repository of data points reflecting real world provider activities for a fleet of provider devices and corresponding providers interacting across a transportation matching system. Moreover, the disclosed systems transform these data points into intelligent provider device performance metrics relevant to analyzing and inferring provider performance and characteristics. Indeed, the disclosed systems can analyze these provider device performance metrics to intelligently infer real world characteristics of one or more providers. In addition, the disclosed systems can utilize a generative model to generate a customized text summary reflecting characteristics of a provider inferred from the provider device performance metrics. In some embodiments, the disclosed systems generate a third-party referral document comprising the customized text summary as well as additional provider information pertinent to a referral objective. Furthermore, the disclosed systems can transmit the digital third-party referral document to a client device for display via a user interface of the client device. In some cases, the disclosed systems generate a targeted opportunity recommendation for the provider based on the provider device performance metrics.

These, along with additional problems and issues, exist with conventional systems.

### BRIEF DESCRIPTION OF THE DRAWINGS

The detailed description refers to the drawings briefly described below.

FIG. 1 illustrates an example overview diagram of a referral generation system generating a digital third-party referral document and a targeted opportunity recommendation in accordance with one or more embodiments.

FIG. 2 illustrates an example of the interaction between server(s), a provider device, and a third-party device to generate a digital third-party referral document in accordance with one or more embodiments.

FIG. 3 illustrates an example of the interaction between server(s), a provider device, and a third-party device to generate a targeted opportunity recommendation and a provider placement map in accordance with one or more embodiments.

FIG. 4 illustrates an example diagram of the referral generation system utilizing provider device performance metrics and additional performance metrics to generate provider device comparison metric(s) in accordance with one or more embodiments.

FIG. 5 illustrates an example diagram of the referral generation system utilizing a template model to generate a digital third-party referral document and targeted opportunity recommendation in accordance with one or more embodiments.

FIG. 6 illustrates mapping provider device performance metrics to inferred characteristics and associated text in accordance with one or more embodiments.

FIG. 7 illustrates an example of the referral generation system utilizing a heuristic generative model to generate a customized text summary for a digital third-party referral document and/or a targeted opportunity recommendation in accordance with one or more embodiments.

FIG. 8 illustrates an example diagram of the referral generation system utilizing a large language model referral prompt to cause a large language model to generate a digital third-party referral document and/or a targeted opportunity recommendation in accordance with one or more embodiments.

FIG. 9 illustrates an example of utilizing a graphical user interface of the referral generation system to instigate the generation of a digital third-party referral document in accordance with one or more embodiments.

FIG. 10 illustrates an example of utilizing a graphical user interface of the referral generation system to customize a digital third-party referral document in accordance with one or more embodiments.

FIG. 11 illustrates an example of utilizing a graphical user interface of the referral generation system to review a digital third-party referral document in accordance with one or more embodiments.

FIG. 12 illustrates an example of a PDF of a digital third-party referral document provided by the referral generation system in accordance with one or more embodiments.

FIG. 13 illustrates an example of utilizing a graphical user interface of the referral generation system to transmit a digital third-party referral document in accordance with one or more embodiments.

FIG. 14 illustrates an example of utilizing a graphical user interface of the referral generation system to collect feedback from a provider device in accordance with one or more embodiments.

FIG. 15 illustrates an example of utilizing a graphical user interface of the referral generation system to instigate the generation of a targeted opportunity recommendation in accordance with one or more embodiments.

FIG. 16 illustrates an example of utilizing a graphical user interface of the referral generation system to generate a targeted opportunity recommendation in accordance with one or more embodiments.

FIG. 17 illustrates a block diagram of an environment for implementing a referral generation system in accordance with one or more embodiments.

FIG. 18 illustrates an example series of acts for generating and providing a digital third-party referral document in accordance with one or more embodiments.

FIG. 19 illustrates a block diagram of a computing device for implementing one or more embodiments of the present disclosure.

FIG. 20 illustrates an example environment for the referral generation system in accordance with one or more embodiments.

### DETAILED DESCRIPTION

This disclosure describes one or more embodiments of a referral generation system that transforms collected data points and relevant provider device performance metrics into intelligently inferred provider characteristics and utilizes a generative model to generate customized digital third-party referral documents as well as refer providers to targeted opportunities based on the determined characteristics of the providers inferred from the provider device performance metrics. For example, in one or more implementations, the referral generation system collects data points reflecting a complex interaction of real world activity across provider devices of a transportation matching system. The referral generation system transforms these data points to provider device performance metrics associated with transportation requests fulfilled by the provider device, where the provider device performance metrics reflect intelligent, relevant digital performance indicators corresponding to a provider. In addition, the referral generation system can utilize a generative model to dynamically generate and/or analyze these intelligent performance metrics to infer real world characteristics pertinent to a referral objective for the provider.

Moreover, the referral generation system can utilize these characteristics to generate a customized text summary indicating real world performance characteristics. In some embodiments, the referral generation system generates a third-party referral document comprising the customized text summary as well as additional pertinent data corresponding to the provider and the referral objective. Furthermore, the referral generation system can transmit the digital third-party referral document to a client device for display via a user interface of the client device. In some cases, the referral generation system generates a targeted opportunity recommendation for the provider based on the provider device performance metrics. Thus, the referral generation system can provide a variety of improvements to conventional systems in accuracy, efficiency, and flexibility of generative tasks for one or more referral objectives by monitoring data points across a network of provider devices, transforming these data points to relevant performance metrics, intelligently analyzing the performance metrics to determine real world provider characteristics, and utilizing generative models to create referral documents that accurately reflect these characteristics and other pertinent information for a referral objective.

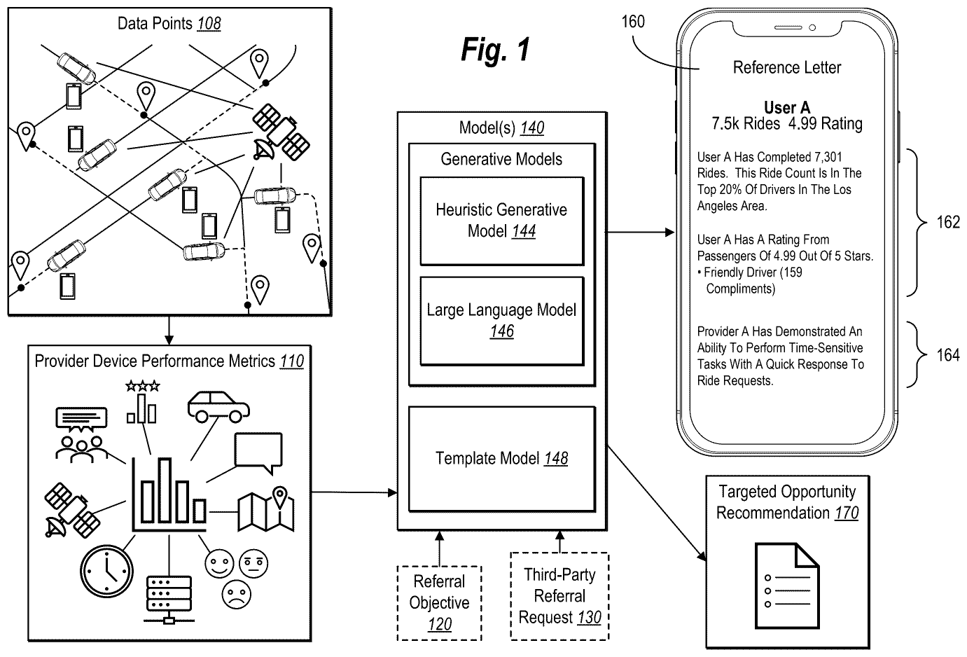

As shown in FIG. 1, a referral generation system 100 can generate a digital third-party referral document 160 and/or a targeted opportunity recommendation 170 for a provider associated with a client device. In particular, the referral generation system 100 can utilize a model such as a heuristic generative model 144, a large language model 146, or a template model 148 to generate the digital third-party referral document 160 from the provider device performance metrics 110 (generated from data points 108), a referral objective 120, and/or a third-party referral request 130. In some cases, the referral generation system 100 can utilize a model such as the heuristic generative model 144, the large language model 146, or the template model 148 to generate the targeted opportunity recommendation 170 from the provider device performance metrics 110, the referral objective 120, and/or the third-party referral request 130.

For example, referral generation system 100 can generate the digital third-party referral document 160 to highlight the performance, skills, and behavior (e.g., characteristics) of a provider based on measurable data (e.g., provider device performance metrics 110) and contextual insights. For example, the third-party referral document can include additional provider details such as provider device performance metrics 110 and/or metric comparisons between the provider and additional providers (e.g., section 162). For example, the digital third-party referral document 160 can include performance data tailored to the referral objective 120—such as a job application, a professional evaluation, proof of employment, immigration documents, or a mortgage application (e.g., section 164). Furthermore, the referral generation system 100 can generate the targeted opportunity recommendation 170 including a match between the provider to the third-party referral request 130. To illustrate, based on characteristics inferred from the provider device performance metrics 110 and traits associated with the third-party referral request 130, the referral generation system 100 can generate the targeted opportunity recommendation 170.

To illustrate, the referral generation system 100 generates the digital third-party referral document 160 and/or a targeted opportunity recommendation 170 based on the data points 108. In one or more embodiments, the referral generation system 100 can collect the data points 108 by capturing (real world) activity performed by a provider associated with transportation requests fulfilled by a provider device. For example, the referral generation system 100 can collect the data points 108 such as location data (utilizing a plurality of GPS systems of various provider devices), transportation times, travel speed, route efficiency, telematics, time of service completion, and other data obtained by monitoring a provider device. In some embodiments, the referral generation system 100 can obtain additional data for the data points 108 associated with transportation requests fulfilled by a provider device including customer feedback, ratings, and incidents reported during transportation requests. Based on the data points 108, the referral generation system 100 can perform an analysis to extract meaningful patterns or indicators of performance (e.g., the provider device performance metrics 110).

Furthermore, the referral generation system 100 can generate the provider device performance metrics 110 including measurable metrics from the data points 108 that capture the operational behavior, efficiency, and effectiveness of a provider associated with a provider device. For example, the model(s) 140 can generate the provider device performance metrics 110 such as provider device response times for trip requests, provider device adherence to optimal routes, provider device efficiency, or provider device customer satisfaction. The model(s) 140 can also aggregate the data points 108 and/or the provider device performance metrics 110 to generate aggregated metrics for the provider device performance metrics 110 such as average provider device response times, aggregated provider satisfaction scores, aggregated provider safety scores, or compare completed transportation requests against expected service standards for a provider device. In some embodiments, the model(s) 140 generates the provider device performance metrics 110 by comparing the provider device with additional provider devices in a geographic region shared between the provider device and the additional provider devices (e.g., operating under similar transportation constraints associated with a geographic region).

As mentioned, the referral generation system 100 can generate the digital third-party referral document 160 and/or the targeted opportunity recommendation 170 from a referral objective 120. For example, the referral generation system 100 can utilize the referral objective to provide context for customizing the digital third-party referral document 160 and/or the targeted opportunity recommendation 170. In some cases, the referral objective 120 can include a context such as securing the digital third-party referral document 160 for employment, a loan application, a professional evaluation, or generating the targeted opportunity recommendation 170.

To illustrate, the referral generation system 100 can, in response to the third-party referral request 130, generate the digital third-party referral document 160 including a customized text summary and/or additional provider details corresponding to the referral objective. For example, the model(s) 140 can determine one or more inferred characteristics of the provider by analyzing the provider device performance metrics 110. Moreover, the model(s) 140 can analyze the provider device performance metrics 110 to identify correlations between the inferred characteristics and the provider device performance metrics 110. Additionally, the model(s) 140 can utilize the correlations to infer characteristics of the provider corresponding to the referral objective 120. Based on the correlations and/or the inferred characteristics, the referral generation system 100 can generate a customized text summary.

For example, the referral generation system 100 can provide a customized text summary that describes the inferred characteristics using a tailored narrative that highlights the inferred characteristics, identifies patterns for the inferred characteristics, and/or provides connections between the inferred characteristics and the third-party referral request 130. For instance, the model(s) 140 can infer characteristics such as “punctuality” from a provider device consistently meeting estimated arrival times, “efficiency” from a provider device minimizing route deviations, or “customer-centric behavior” from high provider ratings and positive comments. The referral generation system 100 can synthesize the inferred characteristics into a customized text summary to describe the provider as “highly dependable and efficient, with a track record of exceptional customer service.” Furthermore, the referral generation system 100 can include additional provider details in the digital third-party referral document 160 utilizing the provider device performance metrics 110 such as “the provider met estimated arrival times in 68 out of 73 cases for the last 30 days.”

As also shown in FIG. 1, the referral generation system 100 can generate the digital third-party referral document 160 and/or the targeted opportunity recommendation 170 based on a third-party referral request 130. For example, the referral generation system 100 can customize the digital third-party referral document 160 and/or the targeted opportunity recommendation 170 based on the third-party referral request 130 including a request to fulfill a particular need, such as the performance of a job, task, or service. The referral generation system 100 can customize the digital third-party referral document 160 and/or the targeted opportunity recommendation 170 based on identifying traits associated with the third-party referral request 130.

As mentioned, in some embodiments, the referral generation system 100 utilizes one or more of the model(s) 140 to generate the digital third-party referral document 160 and/or the targeted opportunity recommendation 170. For example, in one or more embodiments, the referral generation system 100 utilizes the heuristic generative model 144 to generate the digital third-party referral document 160. For example, utilizing the heuristic generative model 144, the referral generation system 100 can use structured rules and adaptive learning to provide a logical framework and generate the referral document. Additionally, the heuristic generative model 144 can utilize learned patterns to generate customized content specific to the provider device performance metrics 110. To illustrate, the heuristic generative model can create customized text summaries based on values of the provider device performance metrics 110 or highlight characteristics of the provider associated with the provider device performance metrics 110.

Similarly, the referral generation system 100 can utilize the heuristic generative model 144 to generate the targeted opportunity recommendation 170. In particular, the referral generation system 100 can apply rule-based logic to evaluate the alignment between provider characteristics associated with the provider device performance metrics 110 and traits associated with the third-party referral request 130. To illustrate, the referral generation system 100 can apply rules to evaluate the alignment between the provider device performance metrics 110 and the third-party referral request 130. Based on the strength of the match, the referral generation system 100 can include the third-party referral request 130 in the targeted opportunity recommendation 170.

As also shown in FIG. 1, the referral generation system 100 can utilize a large language model 146 to generate the digital third-party referral document 160 and/or the targeted opportunity recommendation 170. For example, the referral generation system 100 can utilize the large language model 146 to generate the digital third-party referral document 160 based on a large language model prompt which includes a referral task description, the provider device performance metrics 110, and/or example third-party referral documents. Utilizing the large language model 146, the referral generation system 100 can infer provider characteristics (e.g., efficient) from the provider device performance metrics 110 to generate customized content for the digital third-party referral document 160. Similarly, the referral generation system 100 can utilize the large language model 146 to generate the targeted opportunity recommendation 170. For example, the referral generation system 100 can utilize the large language model 146 to produce context-aware recommendations tailored to align providers with specific tasks or roles (e.g., the third-party referral request 130).

As also shown in FIG. 1, the referral generation system 100 can utilize a template model 148 to generate the digital third-party referral document 160 and/or the targeted opportunity recommendation 170. For example, referral generation system 100 can combine a predefined structure with content generated from the provider device performance metrics 110, the referral objective 120, and/or the third-party referral request 130. For example, the referral generation system 100 populates placeholder fields within a template digital third-party referral document with values generated from the provider device performance metrics 110 to generate the digital third-party referral document 160. In some cases, the referral generation system 100 can utilize a comparison threshold to include specific metrics from the provider device performance metrics 110 and/or to select portions of the template digital third-party referral document to include within the digital third-party referral document 160. Similarly, the referral generation system 100 can utilize the template model 148 to generate the targeted opportunity recommendation 170. In some cases, the referral generation system 100 can utilize a comparison threshold to include the third-party referral requests that are matched to provider characteristics associated with the provider device performance metrics 110.

As mentioned, current systems have a number of technical shortcomings, particularly in terms of flexibility, accuracy, operational efficiency, and data security. For example, current systems are inflexible. In particular, current transportation systems are often rigid and focused on generating transportation matches or other intelligent coordination across computer devices. However, such systems fail to utilize dynamic performance metrics for intelligent generative purposes. For instance, conventional systems lack the adaptability to generate custom referral documents based on the individual requirements of provider device requests or specific third-party referral requests. For example, current systems lack the flexibility to customize content for referral documents in a way that aligns with task-specific needs (e.g., to highlight the characteristics or experience of providers based on different referral objectives). Furthermore, the absence of a persistent data structure exacerbates these limitations inasmuch as conventional systems also provide no option to validate generative content effectively.

Similarly, current systems are inflexible in failing to utilize transportation performance metrics to generate placement recommendations. For example, current systems lack the flexibility to generate placement recommendations based on multi-factor inputs from provider device performance metrics. This absence of flexible data integration hinders the ability of current systems to provide contextually appropriate placement recommendations based on specific referral objectives.

Although some generic document generation systems exist, such systems suffer from additional inflexibility and inaccuracies when generating referral documents and/or placement recommendations. As an initial matter, such conventional systems often suffer from data sparsity in data signals to generate referral documents. Extracting and utilizing data points for provider devices across computer networks provides a unique, flexible source for generative content that previous systems have been unable to utilize. For example, current systems often include generalized content in referral documents, rather than providing precise performance indicators that clearly convey a provider device performance.

To illustrate, current systems are unable to incorporate GPS data to generate region-specific analytics or generate metrics customized to specific geographic regions. Without using regional customization, the referral documents generated by current systems may include inaccurate or misleading metrics. For instance, the performance of one provider device in one geographic location may not be comparable to the performance of another provider device in separate geographic location, leading current systems to generate less accurate (or misleading) metrics for referral documents. Furthermore, current systems often lack the ability to customize placement recommendations based on multi-factor inputs and inferred characteristics, such as combining traits like reliability, timeliness, and geographic location to determine accurate recommendations.

Furthermore, current document generation systems are operationally inefficient and frequently require excessive device interactions to generate documents. For example, current systems often require multiple device interactions to gather, compile, and verify data to generate referral documents (e.g., user device interactions and device transmissions). For example, current systems often incorporate inefficient user device interfaces which require excess device interactions to generate and select referral document content. Furthermore, current systems often discard referral documents after use (e.g., without utilizing a persistent data repository), compounding the operational inefficiencies of current systems. For example, with many current systems, each request for a referral document initiates a fresh cycle of device interactions, data retrieval, and document generation to regenerate the referral document. These inefficiencies of current systems result in additional processing costs, network traffic, and an increased device workload.

Moreover, many document generation systems lack robust security measures to protect referral document content and/or ensure referral document authenticity. For example, current systems lack secure verification methods to authenticate referral documents. Indeed, the unverified documents of current systems are more vulnerable to fraud, in part due to the lack of reliable methods to confirm that the referral documents are genuine. Additionally, in some current systems, third-party comments exposing potentially sensitive data and compromise privacy. Other current systems comment security measures and exclude third-party comments entirely, thereby excluding valuable qualitative insights associated with comments from generated referral document.

In contrast to current systems, the referral generation system 100 can improve flexibility, accuracy, operational efficiency, and data security over current systems. For example, the referral generation system 100 can flexibly generate digital third-party referral documents customized to varied provider device requirements (e.g., provider device performance metrics, referral objectives, third-party referral requests). For example, based on an analysis of provider device performance metrics, the referral generation system 100 customizes the content of digital third-party referral documents according to the referral objectives and/or third-party referral requests. Indeed, unlike current systems, the referral generation system 100 can generate tailored digital third-party referral documents that selectively incorporate targeted device performance metrics. Moreover, by utilizing a persistent data structure, the referral generation system 100 can maintain and provide multiple digital third-party referral documents associated with the provider device which incorporate different content, different timestamps, and/or different customization.

Furthermore, the referral generation system 100 can provide advantages in flexibility over current systems. For example, the referral generation system 100 can generate targeted opportunity recommendations that match third-party provider requests (or referral opportunities) to the provider based on multi-factor inputs including provider device performance metrics. For example, the referral generation system 100 can generate targeted opportunity recommendations that include particular third-party provider requests that are customized to characteristics (and referral objectives) of the providers.

The referral generation system 100 also addresses data sparsity problems that plague conventional systems. Indeed, the referral generation system 100 can monitor data points of provider devices across a transportation network over time, including time, speed, location/GPS, telematics, inter-device comments/ratings, etc. The referral generation system 100 can transform these data points to pertinent provider referral metrics and intelligently infer provider characteristics in generative processes to create referral documents. Thus, the referral generation system 100 uniquely addresses data sparsity of other systems by monitoring real world data points via provider devices and transforming those data points through a generative process to accurately inferred characteristics to include within referral digital documents.

As also mentioned, the referral generation system 100 provides advantages in accuracy over current systems. For example, the referral generation system 100 uses provider device performance metrics to provide accurate, up-to-date, data-driven metrics for digital third-party referral documents. Indeed, the referral generation system 100 generates a precise and objective assessment of provider performance using provider device performance metrics including an objective assessment of provider performance relative to other providers. In addition, the referral generation system 100 can use region-specific analytics based on specific geographic regions (e.g., using GPS data) to generate accurate context-based performance metrics comparing provider performance relative to other providers. By evaluating provider performance based on a geographic region, the referral generation system 100 can generate provider metrics tailored to actual conditions (e.g., traffic patterns, service demand) faced by the provider which accurately convey provider performance in context. Furthermore, the referral generation system 100 can generate targeted opportunity recommendations for providers tailored to the provider device performance metrics which results in more accurate recommendations that are based on the characteristics of the providers.

In one or more implementations, the referral generation system also significantly enhances operational efficiency by streamlining the creation of digital third-party referral documents. For example, the referral generation system 100 can generate digital third-party referral documents that incorporate objective metrics based on a minimum number of device interactions. Indeed, based on minimal user device interactions and minimal device transmissions, the referral generation system 100 can obtain performance metrics, analyze the performance metrics, and compile the performance metrics to generate verifiable data-driven digital third-party referral documents for a provider device. Similarly, rather than requiring excess device interactions, the referral generation system 100 seamlessly aligns provider characteristics with third-party referral requests to generate targeted opportunity recommendations for providers.

Moreover, the referral generation system 100 can provide enhanced security features over current systems. For example, the referral generation system 100 can incorporate a digital third-party referral document verification process to ensure the authenticity and security of the digital third-party referral documents. For example, the referral generation system 100 filters requestor comments to exclude potentially sensitive data (e.g., PII) before incorporating the requestor comments into digital third-party referral documents. Furthermore, the referral generation system 100 authenticates the digital third-party referral documents through a verification process. For example, the referral generation system 100 can utilize verification links and/or QR codes to enable the third party devices to verify the digital third-party referral document.

As indicated by the foregoing discussion, the present disclosure utilizes a variety of terms to describe features and advantages of the referral generation system 100. For example, as used herein, the term “provider device” refers to a computing device associated with a transportation provider or provider (e.g., a human provider or an autonomous computer system provider) that operates a transportation vehicle. For instance, a provider device refers to a mobile device such as a smartphone or tablet operated by a provider—or a device associated with an autonomous vehicle that drives along transportation routes. Relatedly, the term “requestor device” refers to a computing device associated with a requestor that submits a transportation request to a transportation matching system. For instance, a requestor device receives interaction from a requestor in the form of user interaction to submit a transportation request. As used herein, the term “third-party device” includes or refers to a device that is not directly owned, controlled, or produced by a transportation matching system, but is instead provided or operated by an external system. For example, a third-party device includes a device the referral generation system 100 communicates with to provide or verify a digital third-party referral document.

As used herein, the term “transportation request” refers to a request from a requesting device (i.e., a requestor device) for transport by a transportation vehicle. In particular, a transportation request includes a request for a transportation vehicle to transport a requestor or a group of individuals from one geographic area to another geographic area. A transportation request can also include a requestor device initiating a session via a transportation matching application and transmitting a current location (thus, indicating a desire to receive transportation services from the current location).

As used herein, the term “provider device request” refers or includes a request from a provider device to generate data related to the referral generation system 100. For example, the provider device request can include a request from a provider device within a graphical user interface to generate a digital third-party referral document. In some embodiments, the referral generation system 100 provides configuration options to customize the provider device request. Relatedly, the term “referral objective” includes or refers to a specific purpose or context for the provider device request. The referral objective can encompass contexts such as securing the digital third-party referral document for employment, a loan application, or other opportunities. The referral objective can encompass contexts such as generating a targeted opportunity recommendation for roles associated with a specific expertise or type of task.

As used herein, the third-party referral request includes or refers to an inquiry of a third-party describing a particular need, such as the performance of a job, task, or service In some cases, the third-party referral request includes (or is associated with) traits required for the need, such as responsiveness, reliability, or safety. In some cases, a third-party referral request can include the requirements or objectives of the third-party need and serve as the basis for identifying suitable candidates or providers. In some cases, a third-party referral request includes a request seeking a match with a provider and/or a listing of providers with characteristics that could fulfill the particular need (e.g., a provider placement map).

As used herein, the term “digital third-party referral document” includes or refers to an electronically generated digital document associated with a provider device (for distribution to one or more third-parties as a referral source). For example, a digital third-party referral document can highlight the performance, skills, and behavior (e.g., characteristics) of a provider based on measurable data and contextual insights. For example, the third-party referral document can include quantitative data (e.g., provider device performance metrics) and qualitative evaluations (e.g., metric comparisons between providers). The digital third-party referral document can include performance data tailored to a specific purpose or audience (e.g., a referral objective), such as a job application, a professional evaluation, proof of employment, or a mortgage application. A digital third-party referral document and may contain structured data, links, or digital signatures to verify authenticity and allow for distribution across electronic communication channels. In some cases, the digital third-party referral document includes performance metrics, feedback, qualifications, skills, or attributes relevant to a referral opportunity (e.g., task, context, purpose, position, or assignment).

As used herein, the term “targeted opportunity recommendation” (or “targeted placement recommendation”) includes or refers to a customized recommendation that includes tasks, roles, or opportunities matched to a specific provider. For example, a targeted opportunity recommendation includes a match between a provider and a third-party referral request (or referral opportunity) based on matching traits associated with one or more third-party referral requests to the provider. In some cases, the referral generation system 100 determines the match of the provider to the third-party referral request(s) based on provider device performance metrics. For example, a targeted opportunity recommendation can include specific tasks or opportunities for the provider based on a match between characteristics inferred from the provider device performance metrics and traits associated with the third-party referral request(s).

As used herein, the term “provider device performance metrics” include or refer to measurable data points corresponding to a provider associated with a provider device (e.g., that capture the operational behavior, efficiency, and performance of a provider associated with a provider device). In some embodiments, the provider device performance metrics include a transportation match count, a utilization time, a provider device tier, provider star rating, telematics metrics, a provider device safety rating, a requestor device feedback count, requestor device comments, provider device extracurriculars, superlatives (e.g., ratings in friendliness, cleanliness, driving), and/or rider feedback. In some embodiments, the provider device performance metrics include metrics comparing the provider device with additional provider devices in a geographic region shared between the provider device and additional provider devices (e.g., operating under similar transportation constraints associated with a geographic region).

As used herein, the term “geographic region” includes or refers to a defined area within which the transportation matching system facilitates transportation requests between provider devices and requestor devices. For example, a geographic region can be segmented based on population density, demand patterns, road systems, and service availability. Furthermore, the transportation matching system can associate transportation matches for a provider device with one or more geographic regions. In some embodiments, the transportation matching system can use GPS data, Wi-Fi positioning, or cell tower triangulation to determine the location of provider devices within a geographic region. For instance, the transportation matching system can track/detect real-time data associated with provider devices to determine the geographic region where the provider devices provide transportation services.

Relatedly, as used herein, the term “global positioning data” (or “GPS information”) refers to location information provided by a global positioning system corresponding to geographic position. In particular, global positioning data includes digital data reflecting a location of a provider device. For example, the referral generation system 100 and/or a provider device can communicate with satellites of a global positioning system to determine coordinates of the provider devices. Moreover, the provider devices can transmit global positioning data to one or more servers.

As used herein, the term “generative model” includes or refers to a model that constructs and implements algorithms that can generate digital content from data (e.g., intelligently generate one or more documents from data). In some cases, the generative model generates content for a digital third-party referral document from device performance metrics. For example, the generative model can include a machine-learning model (e.g., decision tree, neural network, or large-language model). Similarly, the generative model can include a heuristic generative model or a machine-learning model which is a large language model such as a computer algorithm or a collection of computer algorithms that can be trained and/or tuned based on inputs to approximate unknown functions.

For example, the term “heuristic generative model” includes or refers to a model that utilizes rule-based strategies to generate output. For example, the referral generation system can utilize a heuristic generative model to infer characteristics from provider device performance metrics using contextual analysis. Based on the provider device performance metrics, the heuristic generative model can utilize heuristics to map the provider device performance metrics to inferred characteristics and map the inferred characteristics to associated text. In some embodiments, the referral generation system utilizes a heuristic generative model to extract traits from unstructured or semi-structured third-party referral requests using contextual analysis.

A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

Relatedly, a large language model includes a machine learning model trained to perform computer tasks to generate or identify patterns in textual content in response to trigger events (e.g., user interactions, such as text queries). In particular, a large language model can be a neural network (e.g., a deep neural network having a transformer architecture) with many parameters trained on large quantities of data (e.g., unlabeled text) using a particular learning technique (e.g., self-supervised learning). For example, a large language model can include parameters trained to generate or identify patterns in textual content based on various contextual data, including information from a large corpus of linguistic content. In particular, a large language model can include parameters trained (e.g., via deep learning) on large data volumes to learn patterns and rules of language for summarizing and/or generating digital content. Examples of large language model include BLOOM, Bard AI, ChatGPT (e.g., GPT-3, GPT-4, etc.), LaMDA, and/or DialoGPT. Moreover, in some embodiments a language transformer model includes bidirectional encoder representations (BERT), Robustly optimized BERT (RoBERTa), and other text transformer models. In one or more embodiments, the referral generation system 100 trains the large language model to optimize/generate content for the digital third-party referral document. Specifically, the referral generation system 100 utilizes a training dataset containing a plurality of data (e.g., device performance metrics) and further uses the large language model to generate the digital third-party referral document. Further, the referral generation system 100 generates the digital third-party referral document and compares the digital third-party referral document to a ground truth document. Based on the comparison, the referral generation system 100 determines discrepancies between the digital third-party referral document and the ground truth document (e.g., a loss function). Moreover, the referral generation system 100 uses the loss function to adjust the large language model. For example, the referral generation system 100 computes gradients, which represent the sensitivity of the large language model, to changes in the parameters (e.g., weights and biases) of the large language model. The referral generation system 100 computes the gradients using backpropagation, by calculating how much to adjust the parameters of the large language model to minimize the loss. Based on the gradients, the referral generation system 100 further modifies parameters of the large language model (e.g., based on a measure of loss). The referral generation system 100 utilizes an iterative training process with multiple epochs, each consisting of many batches of data. In each epoch, the referral generation system 100 updates the parameters of the large language model using the calculated gradients, gradually improving the performance of the large language model by minimizing the loss.

As used herein, the term “persistent data repository” includes or refers to a storage system which retains and manages digital records (e.g., digital third-party referral documents). For example, the persistent data repository includes one or more servers that store digital content including data points for the digital third-party referral document. In some cases, the referral generation system 100 associates (and stores) a referral identifier for the digital third-party referral document with the data points for the digital third-party referral document within the persistent data repository. To illustrate, based a digital verification request from a third-party which includes a referral identifier, the referral generation system 100 can access the data points for the digital third-party referral document and generate (or re-generate) the digital third-party referral document 160.

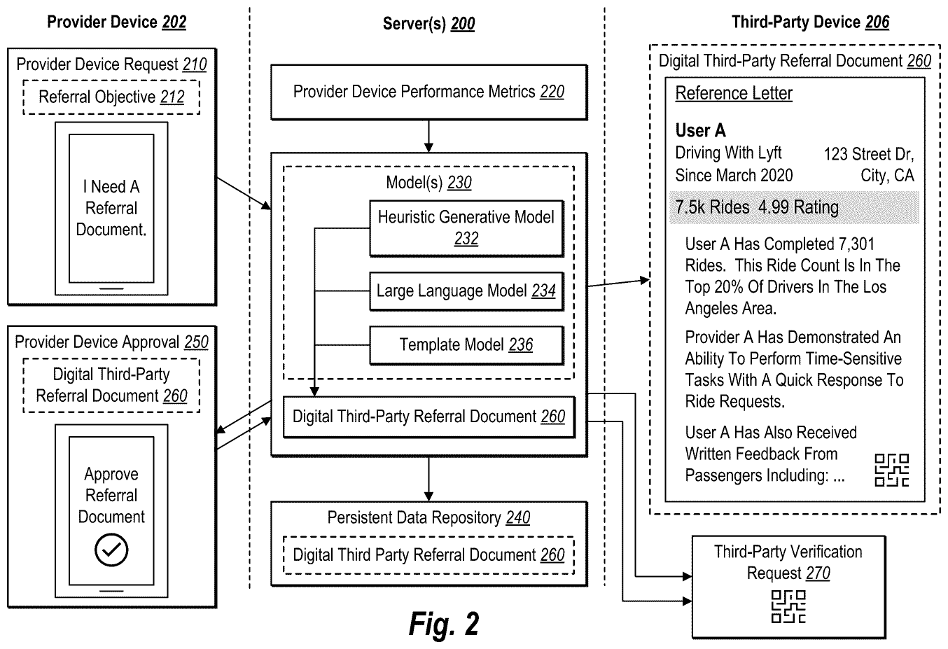

As mentioned, the referral generation system 100 can coordinate between a provider device and a third-party device to generate digital third-party referral documents. FIG. 2 illustrates an example of the interaction of a referral generation system 100 between one or more servers, a provider device, and a third-party device to generate a digital third-party referral document 260 in accordance with one or more embodiments.

As shown in FIG. 2, the server(s) 200 interact with a provider device 202 and a third-party device 206 to generate and provide a digital third-party referral document 260. In one or more embodiments, based on a provider device request 210, such as a user interaction with a digital third-party referral request element of a transportation matching application, the server(s) 200 can identify a request to generate a digital third-party referral document 260 corresponding to a referral objective 212.

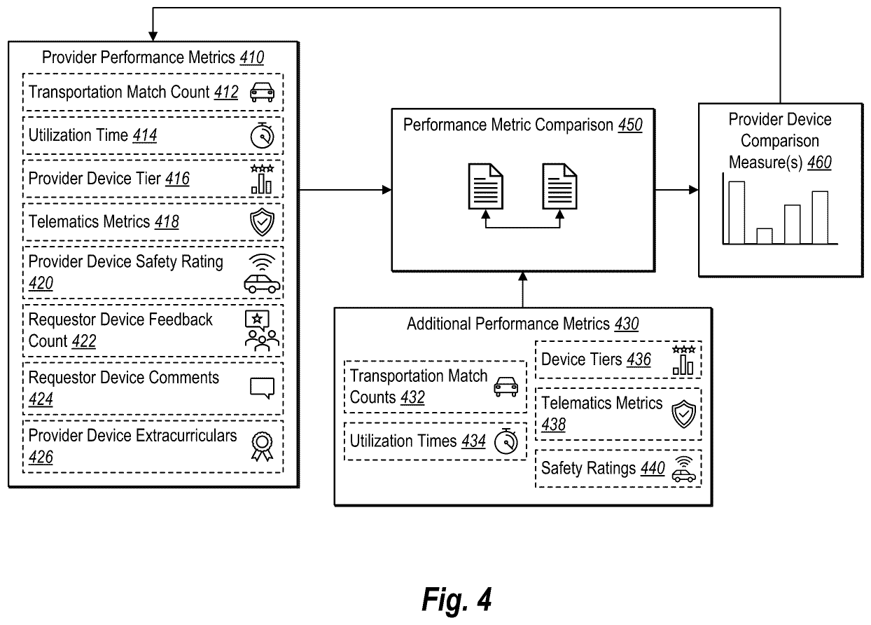

As discussed in more detail in relation to FIGS. 4-8, the referral generation system 100 can utilize one or more of the model(s) 230 (e.g., heuristic generative model 232, large language model 234, or template model 236) to generate the digital third-party referral document 260 based on the provider device request 210. For example, the server(s) 200 extract the provider device performance metrics 220 associated with transportation requests fulfilled by a provider device. In one or more embodiments, the server(s) 200 can extract the provider device performance metrics 220 including data points that capture activity performed by a provider associated with transportation request fulfilled by the provider device 202. Furthermore, the server(s) 200 can generate the digital third-party referral document 260 to include a customized text summary and additional provider details corresponding to the referral objective. In some embodiments, the server(s) 200 generate a digital third-party referral document 260 and provides the digital third-party referral document 260 to the provider device 202 for display via a user interface of the provider device 202.

For example, the server(s) 200 can generate the digital third-party referral document 260 including provider details such as performance metrics, a customized text summary, a comment summary, and/or requestor comments. In some cases, the server(s) 200 can analyze the provider device performance metrics 220 and data points to determine a subset of the provider device performance metrics 220 and data points that are relevant to determining the characteristics of the provider device 202. In some cases, the server(s) 200 can infer characteristic(s) of the provider based on the subset of the provider device performance metrics 220 and data points by determining a correlation between the characteristic(s) and the provider device performance metrics 220 and data points. For example, the server(s) 200 can select one or more of the provider device performance metrics 220 to include in the digital third-party referral document 260 based on an association between a set of characteristics inferred from the provider device performance metrics 220. In some cases, the server(s) 200 can generate a customized text summary for the digital third-party referral document 260 reflecting the characteristic(s) of the provider inferred from the provider device performance metrics 220. In some embodiments, the server(s) 200 can utilize a referral objective 212 to generate the customized text summary for the digital third-party referral document 260 from the provider device performance metrics 220 for the provider device (e.g., customize the customized text summary based on the referral objective 212). In some cases, the server(s) 200 can include requestor comments and/or generate a comment summary to include in the digital third-party referral document 260. As shown in FIG. 2, the server(s) 200 can generate the digital third-party referral document 260 based on the referral objective 212 and the customized text summary and include additional relevant details related to the referral objective 212 and the customized text summary.

As also shown on FIG. 2, the server(s) 200 can interact with the provider device 202, to receive a provider device approval 250. In particular, the provider device 202 can approve the digital third-party referral document 260 by providing the provider device approval 250 to the server(s) 200. For example, the provider device 202 can approve the digital third-party referral document 260 by providing the provider device approval 250 to persist a copy of the digital third-party referral document 260 in a persistent data repository 240. Based on the provider device approval 250, the server(s) 200 save a referral identifier for the digital third-party referral document 260 and data points reflecting contents of the digital third-party referral document 260 within the persistent data repository 240. In this way, the referral generation system 100 can retain one or more versions of the digital third-party referral document 260 for the provider utilizing the persistent data repository 240.

In some cases, the provider device 202 can approve the digital third-party referral document 260 by providing the provider device approval 250 to transmit the digital third-party referral document 260 to the third-party device 206. Based on the provider device approval 250, the server(s) 200 transmit the digital third-party referral document 260 to the third-party device 206. For example, the server(s) 200 can transmit the digital third-party referral document 260 including a referral identifier to identify the digital third-party referral document 260. In one or more embodiments, the server(s) 200 utilize a digital identifier that is a unique representation of data in a digital format, designed to provide access, authentication, or identification for the digital third-party referral document 260 (e.g., QR code, barcode, UUID, digital ID).

As also shown on FIG. 2, the server(s) 200 can interact with the third-party device 206, to verify the digital third-party referral document 260. For example, in response to receiving a third-party verification request 270, the server(s) 200 can provide a verification response to the third-party device 206. In some cases, the server(s) 200 receive the third-party verification request 270 including a referral identifier for the digital third-party referral document 260 and generates a query response by accessing data points reflecting the contents of the digital third-party referral document 260 from the persistent data repository 240. In some cases, in response to receiving the third-party verification request 270 including the digital identifier from the third-party device 206, the server(s) 200 utilize the digital identifier to verify the digital third-party referral document 260 for the third-party device. Based on the verification of the digital third-party referral document 260, the server(s) 200 transmit a digital verification (and/or copy) of the digital third-party referral document 260 to the third-party device 206.

The referral generation system 100 can also utilize the persistent data repository 240 to confirm, extract, or re-build a digital third-party referral document. For example, upon receiving a query regarding a digital third-party referral document, the server(s) 200 can access the persistent data repository (utilizing a unique identifier for any particular referral document) and identify information regarding the digital third-party referral document. To illustrate, the server(s) 200 can access a stored image (e.g., PDF) of a historical digital third-party referral document. Similarly, the server(s) 200 can access indicators of content (e.g., text) for a historical digital third-party referral document. The server(s) 200 can provide a copy of the historical digital third-party referral document in response to the query. In some embodiments, the server(s) 200 can confirm or verify the contents of a historical digital third-party referral document in response to a query.

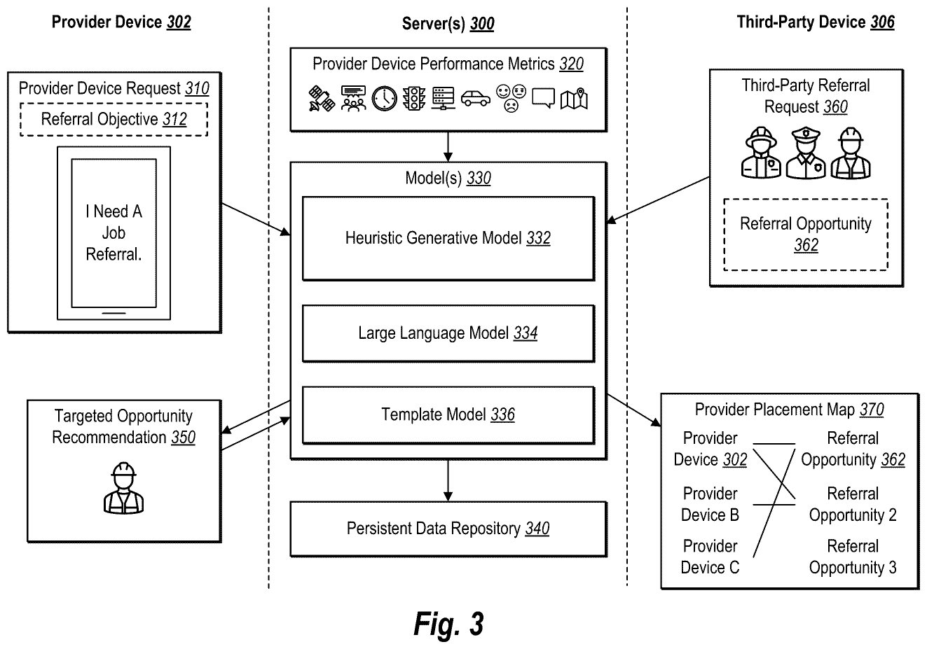

As mentioned, the referral generation system 100 can coordinate between a provider device and a third-party device to generate targeted opportunity recommendations. FIG. 3 illustrates an example of the interaction of a referral generation system between one or more of servers, a provider device, and a third-party device to generate a targeted opportunity recommendation and/or a provider placement map in accordance with one or more embodiments.

As shown in FIG. 3, the server(s) 300 interact with a provider device 302 and a third-party device 306 to generate a targeted opportunity recommendation 350 and/or a provider placement map 370. In one or more embodiments, based on a provider device request 310, such as a user interaction with a digital third-party referral request element of a transportation system, the server(s) 300 can identify a request to generate a targeted opportunity recommendation 350 based on the referral objective 312.

As discussed in more detail below in relation to FIGS. 4-8, the referral generation system 100 can utilize one or more of the model(s) 330 (e.g., heuristic generative model 332, large language model 334, or template model 336) to generate the targeted opportunity recommendation 350 based on the provider device request 310. For example, the server(s) 300 extract a set of provider device performance metrics 320 associated with transportation requests fulfilled by a provider device. In addition, the server(s) 300 determine a set of traits associated with one or more of the third-party referral request 360 received from the third-party device 306. In some cases, the server(s) 300 generate the targeted opportunity recommendation 350 by including on or more of the third-party referral request 360 based on determining an association between the set of provider device performance metrics 320 and the set of traits.

As also shown in FIG. 3, the server(s) 300 can distribute the targeted opportunity recommendation 350. For example, the referral generation system 100 can provide the targeted opportunity recommendation 350 for display via a provider transportation matching application of the provider device 302 associated with the provider. In some embodiments, the referral generation system 100 can store the targeted opportunity recommendation 350 in the persistent data repository 340.

As also shown in FIG. 3, the server(s) 300 can generate a provider placement map 370. For example, the third-party referral request 360 can include a referral opportunity 362 delineating an available position or opportunity associated with the third-party device 306. In some embodiments, third-party device 306 utilizes the third-party referral request 360 to request the provider placement map 370 including a list of providers that have demonstrated characteristics suited to the referral opportunity 362. In some embodiments, the provider placement map 370 can include digital third-party referral documents for the listed providers. Based on the third-party referral request 360, the server(s) 300 can generate the provider placement map 370 associated with a referral opportunity 362 of the third-party referral request 360.

To illustrate, to generate the provider placement map 370, the server(s) 300 extract the set of provider device performance metrics 320 associated with transportation requests fulfilled by a provider device. In addition, the server(s) 300 determine a set of traits associated with the referral opportunity 362 received from the third-party device 306. The server(s) 300 can include the provider associated with the provider device 302 in the provider placement map 370 based on determining an association between the set of provider device performance metrics 320 for the provider device 302 and the set of traits for the referral opportunity 362. In some cases, the server(s) 300 provide the provider placement map 370 for display via the third-party device 306.

As mentioned, in some embodiments, the referral generation system 100 utilizes a variety of device performance metrics to generate provider device performance measures for a provider device. In some cases, the referral generation system 100 utilizes a provider device comparison measure to generate an objective assessment of provider device performance relative to other provider devices. For example, FIG. 4 illustrates an example diagram of the referral generation system 100 utilizing provider device performance metrics and additional performance metrics to generate provider device comparison metrics in accordance with one or more embodiments.

As shown in FIG. 4, the referral generation system 100 extracts provider device performance metrics 410 including objective assessments of provider device performance (e.g., obtained from a transportation matching system). To illustrate, the referral generation system 100 extracts provider device performance metrics 410 associated with transportation requests fulfilled by the provider device. In some cases, the provider device performance metrics 410 include transportation match count 412, utilization time 414, provider device tier 416, telematics metrics 418, provider device safety rating 420, requestor device feedback count 422, requestor device comments 424, provider device extracurriculars 426. In some cases, the additional performance metrics 430 include transportation match counts 432, utilization times 434, device tiers 436, telematics metrics 438, and safety ratings 440. Relatedly, the referral generation system 100 extracts the additional performance metrics 430 associated with transportation requests fulfilled by additional provider devices. In some cases, the additional performance metrics 430 include transportation match counts 432, utilization times 434, device tiers 436, telematics metrics 438, and safety ratings 440.

To illustrate, the referral generation system 100 can extract the transportation match count 412 including or referring to a total number of successful matches made between transportation requests and the provider device within a transportation matching system. Relatedly, the referral generation system 100 can extract the transportation match counts 432 including or referring to a total number of successful matches made between transportation requests and additional provider devices associated with the provider device (e.g., additional provider devices in a geographic region shared between the provider device and the additional provider devices). The transportation match count 412 and/or the transportation match counts 432 can accumulate over a specific period, such as hourly, daily, or monthly. The transportation match count 412 and/or the transportation match counts 432 can be segmented by geographic regions, representing demand patterns for a geographic region.

For example, the referral generation system 100 can extract the utilization time 414. In some cases, the utilization time 414 includes or refers to a total amount of time, or average amount of time, during which a provider device is actively engaged in fulfilling transportation requests (e.g., daily, weekly, monthly). Relatedly, the referral generation system 100 can extract the utilization times 434 including or referring to a total amount of time during which additional provider devices are actively engaged in fulfilling transportation requests (e.g., additional provider devices in a geographic region shared between the provider device and the additional provider devices). For example, the utilization time 414 (and/or the utilization times 434) can refer to a cumulative measure for which the provider device is (and/or the additional provider devices are) matched with and service transportation requests. In some cases, the utilization time 414 (and/or the utilization times 434) refers to a percentage of total available time spent fulfilling transportation requests.

Additionally, the referral generation system 100 can extract the provider device tier 416. In some cases, the provider device tier 416 includes or refers to a classification level assigned to provider devices within a transportation matching system based on specific performance metrics, characteristics, or service attributes. Relatedly, the device tier 436 includes or refers to a classification level assigned to the additional provider devices within a transportation matching system based on specific performance metrics, characteristics, or service attributes for the additional provider devices (e.g., additional provider devices in a geographic region shared between the provider device and the additional provider devices). In some cases, the provider device tier 416 (and/or the device tier 436) assigns a tier or category for the provider device (and/or additional provider devices) that reflects the capabilities, experience, or reliability of the provider device (and/or additional provider devices). In some cases, the referral generation system 100 utilizes the provider device tier 416 and/or the device tier 436 chosen from silver, gold, platinum, and elite tiers.

In some cases, the referral generation system 100 can extract the telematics metrics 418. For example, the telematics metrics 418 includes data points and measurements gathered from telematics systems and/or informatics technology systems to monitor and track provider device logistics in real time. Relatedly, the telematics metrics 438 includes data points and measurements gathered from telematics systems and/or informatics technology systems to monitor and track additional provider device logistics in real time (e.g., additional provider devices in a geographic region shared between the provider device and the additional provider devices). In some cases, the telematics metrics 418 (and/or telematics metrics 438) includes metrics such as operational efficiency, acceleration, speed, safety (e.g., swerving, fast stops, fast acceleration), maintenance, and performance associated with transportation requests.

In some cases, the referral generation system 100 can extract the provider device safety rating 420. For example, the provider device safety rating 420 includes a quantitative or qualitative assessment that represents the safety performance of a provider device. Relatedly, the safety ratings 440 includes a quantitative or qualitative assessment that represents the safety performance of additional provider devices (e.g., additional provider devices in a geographic region shared between the provider device and the additional provider devices). In some cases, the provider device safety rating 420 (and/or the safety ratings 440) incorporates safety metrics including provider device transportation, provider device incident history, provider device safety standard compliance, and provider device operating procedures. In some cases, the provider device safety rating 420 (and/or the safety ratings 440) includes metrics for unsafe driving, provider speeding, aggressive driving, inappropriate provider behavior, provider unsafe behavior, provider photo matching, and unsafe vehicle. In some cases, the referral generation system 100 utilizes provider device safety rating 420 (and/or the safety ratings 440) includes metrics such as:
“TRUST_AND_SAFETY_ALLEGED_ASSAULT_TEMPORARY”,
“TRUST_AND_SAFETY_ALLEGED_DISCRIMINATION_TEMPORARY”,
“TRUST_AND_SAFETY_ALLEGED_DRIVING_SAFETY”,
“TRUST_AND_SAFETY_ALLEGED_HARASSMENT_TEMPORARY”,
“TRUST_AND_SAFETY_ALLEGED_OFF_APP_RIDES_TEMPORARY”,
“TRUST_AND_SAFETY_ALLEGED_SERVICE_ANIMAL_REFUSAL_TEMPORARY”,
“TRUST_AND_SAFETY_ALLEGED_UNSAFE_BEHAVIOR_TEMPORARY”,
“TRUST_AND_SAFETY_ALLEGED_UNSAFE_DRIVING_TEMPORARY”,
“TRUST_AND_SAFETY_ALLEGED_WHEELCHAIR_REFUSAL_TEMPORARY”,
“TRUST_AND_SAFETY_ALLEGED_ZERO_TOLERANCE_TEMPORARY”,
“TRUST_AND_SAFETY_COLLISION_TEMPORARY”,
“TRUST_AND_SAFETY_CONDITIONAL_TEMPORARY”,
“TRUST_AND_SAFETY_REGULATORY_COMPLIANCE_TEMPORARY”,
“TRUST_AND_SAFETY_VEHICLE_CONDITION_TEMPORARY”
“TRUST_AND_SAFETY_ALLEGED_ASSAULT_PERMANENT”,
“TRUST_AND_SAFETY_ALLEGED_DISCRIMINATION_PERMANENT”,
“TRUST_AND_SAFETY_ALLEGED_HARASSMENT_PERMANENT”,
“TRUST_AND_SAFETY_ALLEGED_OFF_APP_RIDES_PERMANENT”,
“TRUST_AND_SAFETY_ALLEGED_SERVICE_ANIMAL_REFUSAL_PERMANENT”,
“TRUST_AND_SAFETY_ALLEGED_UNSAFE_BEHAVIOR_PERMANENT”,
“TRUST_AND_SAFETY_ALLEGED_UNSAFE_DRIVING_PERMANENT”,
“TRUST_AND_SAFETY_ALLEGED_WHEELCHAIR_REFUSAL_PERMANENT”,
“TRUST_AND_SAFETY_ALLEGED_ZERO_TOLERANCE_PERMANENT”,
“TRUST_AND_SAFETY_COLLISION_PERMANENT”,
“TRUST_AND_SAFETY_CONDITIONAL_PERMANENT”,
“TRUST_AND_SAFETY_REGULATORY_COMPLIANCE_PERMANENT”,
“TRUST_AND_SAFETY_SETTLEMENT_PERMANENT”,
“TRUST_AND_SAFETY_SOCIAL_MEDIA_CONCERNS_PERMANENT”,
“TRUST_AND_SAFETY_VEHICLE_CONDITION_PERMANENT”

In some cases, the referral generation system 100 can extract the requestor device feedback count 422. In some cases, the referral generation system 100 can aggregate feedback metrics from the provider device performance metrics 410 to generate the requestor device feedback count 422. For example, the provider device safety rating 420 includes a quantitative assessment of feedback or ratings for a provider device by requestor devices. In some cases, the requestor device feedback count 422 includes aggregated metrics for star ratings, numerical scores, written reviews, or other assessments of a provider device from requestor devices.

In certain cases, the referral generation system 100 can extract requestor device comments 424. In some cases, the referral generation system 100 requestor device comments 424 include superlatives describing qualities associated with the provider device such as cleanliness, driving comfort, approachability, etc. For example, the requestor device comments 424 include free-form textual content submitted by requestor devices which incorporate insights, opinions, or descriptions of requestor device experiences associated with transportation requests fulfilled by a provider device. In some cases, the referral generation system 100 filters the requestor device comments 424 to exclude content containing PII or profanity. In some cases, the referral generation system 100 filters the requestor device comments 424 containing PII or profanity based on comments associated with a provider device during a particular timeframe (e.g., date range, time range, recency), In some cases, the referral generation system 100 filters the requestor device comments 424 to exclude comments associated with a particular topic (e.g., sensitive information, improvement areas) or comments associated with a provider device rating (e.g., negative content).

In certain cases, the referral generation system 100 can extract provider device extracurriculars 426. For example, the provider device extracurriculars 426 include additional skills, qualifications, or activities outside the core transportation service responsibilities for the provider device. In some cases, the provider device extracurriculars 426 include extracurriculars that augment the qualifications of the provider device such as language skills, certifications, special training, or other attributes.

The referral generation system 100 can compare the provider device performance metrics 410 with additional performance metrics assessing the performance of other providers to generate provider device comparison measure(s) 460. For example, the referral generation system 100 can generate the provider device comparison measure(s) 460 for the provider device as a comparison between the provider device performance metrics 410 for the provider device and the additional performance metrics 430 for additional provider devices. In some cases, the referral generation system 100 generates the provider device performance measure(s) 460 by comparing the provider device performance metrics 410 to the additional performance metrics 430 associated with additional provider devices in a geographic region shared between the provider device and the additional provider devices (e.g., operating under similar transportation constraints associated with a geographic region). To illustrate, in some cases, the provider device comparison measure includes a transportation match count proportion (e.g., a proportion of total rides completed by the provider device compared to the average or total ride count of other devices), a utilization time (e.g., an amount of time the provider device is active and available for service relative to the average online time of other devices), a requestor device tier (e.g., a rating of the provider device compared to the average rating across other devices, indicating its quality of service), or a safety rating (e.g., a ranking of the provider device for safety metrics, such as low accident rates or adherence to safety protocols, compared to all providers).

As also shown in FIG. 4, the referral generation system 100 compares the provider device performance metrics 410 with the additional performance metrics 430 to perform the performance metric comparison 450. In particular, the referral generation system 100 generates, from the provider device performance metrics 410 and the additional performance metrics 430, provider device comparison measure(s) 460 between the provider device and the additional provider devices. In particular, the referral generation system 100 compares the transportation match count 412 with the transportation match counts 432, the utilization time 414 with the utilization times 434, the provider device tier 416 with the device tiers 436, the telematics metrics 418 with the telematics metrics 438, and the safety ratings 440 with the safety ratings 440.

For example, the referral generation system 100 utilizes statistical analysis to compare the provider device performance metrics 410 with the additional performance metrics to calculate percentile rankings, averages, or comparison scores. As an example, the referral generation system 100 can determine the provider device has a safety rating in the 90^{th} percentile which signifies better safety performance than 90% of other providers. As another example, the referral generation system 100 can determine the provider device has a 2-minute response time compared to a provider device average of 3 minutes which demonstrates faster-than-average responsiveness. In some cases, the referral generation system 100 can determine the provider device has a transportation match count of 57/63 which represents an excellent match count compared to an average match count of 42/63. In this way, the referral generation system 100 generates concrete objective comparisons for the provider device performance metrics 410 by incorporating the provider device comparison measure(s) 460.

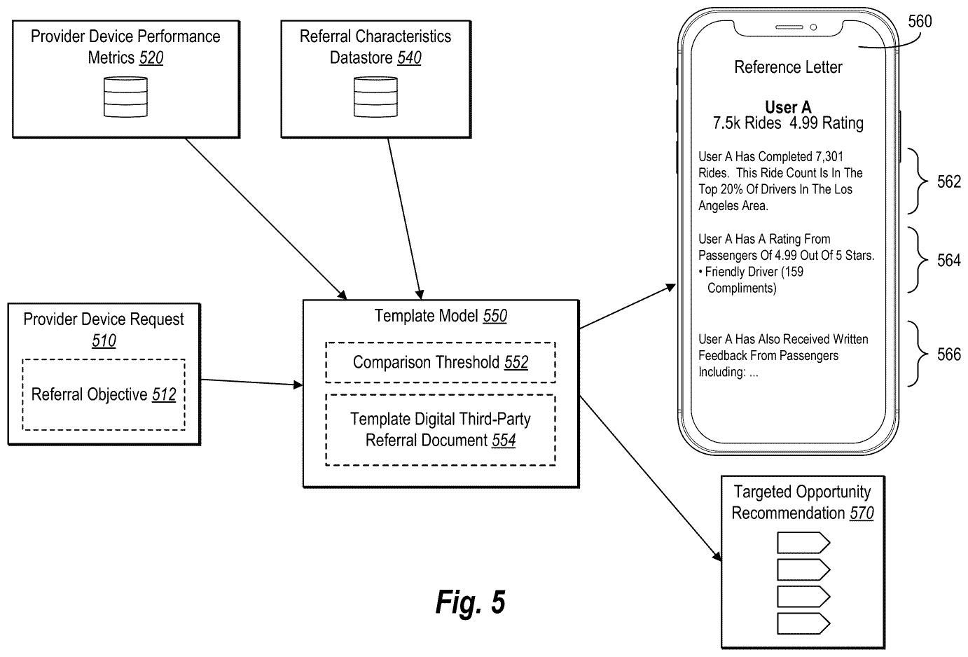

As mentioned, in some embodiments, the referral generation system 100 can utilize a template model to generate the digital third-party referral documents and/or the targeted opportunity recommendations. For example, FIG. 5 illustrates an example diagram of the referral generation system 100 utilizing provider device performance metrics to generate a digital third-party referral document and targeted opportunity recommendation in accordance with one or more embodiments.

As shown in FIG. 5, the referral generation system 100 receives a provider device request 510 to generate a digital third-party referral document 560 and/or a targeted opportunity recommendation 570. Based on the provider device request 510, the template model 550 can generate digital content for the digital third-party referral document 560. For example, the referral generation system 100 can utilize a template digital third-party referral document 554 which incorporates placeholders for provider device attributes such as the provider device performance metrics 520 and inferred characteristics. In some cases, the referral generation system 100 can replace placeholders in the template digital third-party referral document 554 with values for the provider device performance metrics 520 and the inferred characteristics.

For example, the referral generation system 100 can utilize the template model 550 to generate the digital third-party referral document 560 including an objective summarization of the provider device performance metrics. In some embodiments, the referral generation system 100 generates an objective summary 562 for the digital third-party referral document 560 which includes the following metrics:
Transportation Match Count (all provider devices): [First & Last Name] has completed [XXX] rides.
Provider Device Tier (provider devices in top 20%-1% in geographic region): This ride count is in the top [XX%] of providers in the [Geographic region name] region.
Utilization Time (all provider devices): In weeks where [First Name] has given at least 1 ride, [First Names] averages [XX] hours of driving time per week.

In some embodiments, the referral generation system 100 generates the provider metrics 564 which include the following metrics:
Tier (Platinum provider devices): [First Name] is currently ranked as a Platinum provider which is the second highest tier on the Lyft platform. To achieve this tier, Hector met a rigorous threshold for earnings and performance.
Tier (Elite provider devices): [First Name] is currently ranked as an Elite provider which is the highest tier on the Lyft platform. To achieve this tier, Hector met a rigorous threshold for earnings and performance.
Star rating (all provider devices): [First Name] has a rating from passengers of [X. XX] out of 5 stars.
Top tipped (provider devices in top 30% in geographic region): [First Name] has top [XX%] in tips.
Smooth cruiser (all providers): [First Name] has a score of [XX/XX] for smooth driving based on acceleration, braking, and turning.
Preferred provider (all provider devices): [First Name] is preferred by [XX] passengers in the geographic region.
Top X% for safety (provider devices in top 30% in geographic region): [First Name] is in top [XX%] for safety in the geographic region.
Extracurriculars (all provider devices): [First Name] has been accepted into the [XXX] program and has improved their language skills.
Passenger compliments (provider devices with at least 1 compliment): Based on [First Name]'s customer service, passengers have given the following compliments:
   Friendly provider ([X] compliments)
   Clean car ([X] compliments)
   Good driving ([X] compliments)
   Above and beyond ([X] compliments)

In some embodiments, the referral generation system 100 generates the positive requestor device comments 566 which include the following metrics:
Passenger Comments (provider devices who selected at least 1 comment): [First Name]has also received written feedback from passengers, including:
   “[Requestor Device Comment]”

Furthermore, the template model 550 can implement features to customize the digital third-party referral document 560. For example, the referral generation system 100 can customize the format and content of the digital third-party referral document 560 based on a referral objective 512. In some embodiments, the referral objective 512 includes objectives such as a context, purpose, position, role, or assignment associated with generating the digital third-party referral document 560. As mentioned, the template model 550 can generate targeted content for the digital third-party referral document 560 for the provider device that corresponds to specific qualifications or performance standards associated with the referral objective 512.

In some embodiments, the referral generation system 100 can utilize the comparison threshold 552 to select content to include within the template digital third-party referral document 554. For example, the template model 550 can add or remove the provider device performance metrics 520 within the template digital third-party referral document 554 based on one or more of the metrics satisfying the comparison threshold 552. In some cases, the template model 550 can add or remove content (e.g., paragraph, sentence, or metrics) from the template digital third-party referral document based on which of the provider device performance metrics 520 the comparison threshold 552.

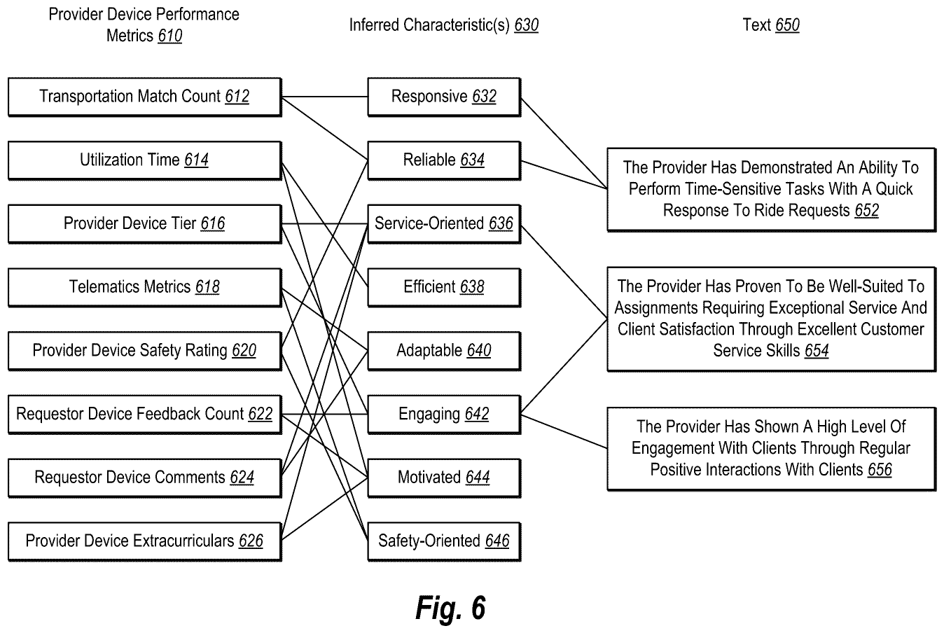

In some cases, the referral generation system 100 utilizes a referral characteristics datastore 540 to maintain a datastore of referral objectives (e.g., referral objective 512) and/or requestor device comments mapped to characteristics. For example, the referral generation system 100 maintains the referral characteristics datastore 540 which includes objectives such as the referral objective 512 and/or common referral objectives associated with generating digital third-party referral documents (e.g., the digital third-party referral document 560) mapped to the inferred characteristics. In some cases, the referral generation system 100 maintains the referral characteristics datastore 540 which includes common words from requestor device comments 424 mapped to the characteristics. In some cases, the referral generation system 100 utilizes a referral characteristics datastore 540 utilizing a mapping such as described below in relation to FIG. 6.

Utilizing the referral characteristics datastore 540, the template model 550 can associate the referral objective 512 with provider device performance metrics 520 and inferred characteristics exhibited by the provider device. In some embodiments, the template model 550 associates the referral objective 512 with provider device performance metrics 520 that correspond to common characteristics such as responsive, reliable, service-oriented, efficient, adaptable, engaging, motivated, safety-oriented, consistent, helpful, or detail-oriented. Furthermore, based on the referral objective 512, the template model 550 can utilize the provider device performance metrics 520 that correspond to the characteristics to generate the digital third-party referral document 560.

To illustrate, the template model 550 can associate the referral objective 512 of “Proof of work” with provider device performance metrics 520 of transportation match count, utilization time, or provider device tier based on characteristics such as reliable, service-oriented, efficient, motivated, and consistent. As another example, the template model 550 can associate the referral objective 512 of “Quality of work” with the provider device performance metrics 520 of provider device tier, telematics metrics, provider device safety rating, or requestor device comments based on characteristics such as commitment to responsive, reliable, service-oriented, efficient, motivated, safety-oriented, consistent, helpful, or detail-oriented. As another example, in embodiments without a referral objective 512 (or with the referral objective 512 of “General”), the template model 550 can include the provider device performance metrics 520 in the digital third-party referral document 560 irrespective of the characteristics (or inclusive of unlimited characteristics).

As also shown in FIG. 5, the referral generation system 100 can utilize the template model 550 to select the provider device performance metrics 520 that satisfy a comparison threshold 552. For example, the template model 550 incorporates one or more of the provider device performance metrics 520 into the digital third-party referral document 560 based on provider device performance metrics 520 that satisfy the comparison threshold 552. In some cases, the template model 550 utilizes the comparison threshold 552 as a predefined standard or value that the provider device performance metrics 520 must meet or exceed to include the provider device performance metrics 520 in the digital third-party referral document 560. In some cases, the comparison threshold 552 includes a fixed numerical value (e.g., a safety rating of 4.5 out of 5). In some cases, the comparison threshold 552 includes a percentile ranking of the provider device compared to other provider devices (e.g., being in the top 10% for utilization time). In some cases, the comparison threshold 552 includes a comparison based on a percentage difference of the performance of the provider device from the average or median performance of other provider devices (e.g., 20% above the average transportation match count).

Similar to the above discussion, the referral generation system 100 can utilize the template model 550 to generate the targeted opportunity recommendation 570. For example, the template model 550 can select third-party referral request(s) for the targeted opportunity recommendation 570 by associating the requirements of third-party referral request(s) to one or more of the provider device performance metrics 520 and/or the associated characteristics. Based on the associations, the template model 550 can populate placeholder fields within a template targeted opportunity recommendation document with the selected third-party referral request(s) to generate the targeted opportunity recommendation 570. To illustrate, the template model 550 can populate a placeholder within the template targeted opportunity recommendation document with a third-party referral request such as “time-sensitive delivery provider” for a provider demonstrating characteristics of “reliable” and “safety-oriented” to generate the targeted opportunity recommendation 570.

In one or more embodiments, the referral generation system 100 can map provider device performance metrics and/or activities to inferred characteristics, which are then mapped to textual content. FIG. 6 illustrates mapping provider device metrics to inferred characteristics and text in accordance with one or more embodiments.

As shown in FIG. 6, the referral generation system 100 can map the provider device performance metrics 610 to inferred characteristic(s) 630 and text 650. For example, the referral generation system 100 can map the provider device performance metrics 610 such as a transportation match count 612, a utilization time 614, a provider device tier 616, telematics metrics 618, a provider device safety rating 620, a requestor device feedback count 622, requestor device comments 624, and provider device extracurriculars 626 to inferred characteristic(s) 630.

To illustrate, the referral generation system 100 can map the provider device performance metrics 610 to inferred characteristic(s) 630 to associate specific behaviors, qualities, or capabilities demonstrated by the provider with characteristics typically associated with third-party referral requests. For example, the referral generation system 100 can map the provider device performance metrics 610 to the inferred characteristic(s) 630 such as responsive 632, reliable 634, service-oriented 636, efficient 638, adaptable 640, engaging 642, motivated 644, and safety-oriented 446. By mapping the provider device performance metrics 610 to the inferred characteristic(s) 630 the referral generation system 100 can provide meaningful context for a digital third-party referral document and/or a targeted opportunity recommendation.

To illustrate, as shown in FIG. 6, the referral generation system 100 can map the provider device performance metrics 610 of the transportation match count 612 to the inferred characteristic(s) 630 of responsive 632 based on inferring a high match count is indicative of quick acceptance/completion of transportation tasks and responsiveness to opportunities. In some cases, the referral generation system 100 can map the provider device performance metrics 610 of the transportation match count 612 to the inferred characteristic(s) 630 of reliable 634 based on an inference that consistently fulfilling transportation matches demonstrates dependability and reliability.

In some embodiments, the referral generation system 100 can map the provider device performance metrics 610 of utilization time 614 to the inferred characteristic(s) 630 of efficient 638 based on an inference that a higher utilization time relative to idle time demonstrates effective time management and productivity. For example, the referral generation system 100 can map the provider device performance metrics 610 of the utilization time 614 to the inferred characteristic(s) 630 of motivated 644 based on an inference that a sustained high utilization corresponds to a strong work ethic and drive to maximize task fulfillment.

In some embodiments, the referral generation system 100 can map the provider device performance metrics 610 of the provider device tier 616 to the inferred characteristic(s) 630 of service-oriented 636 based on an inference that higher-tier providers often meet stringent standards and reflect a focus on service quality. For example, the referral generation system 100 can map the provider device performance metrics 610 of the provider device tier 616 to the inferred characteristic(s) 630 of engaging 642 based on the inference that premium tiers require more interaction with clients, suggesting an ability to maintain positive client relationships.

In some embodiments, the referral generation system 100 can map the provider device performance metrics 610 of the telematics metrics 618 to the inferred characteristic(s) 630 of adaptable 640 based on telematics data, such as route adjustments and speed patterns, reflecting an ability of the provider to adapt to changing conditions. For example, the referral generation system 100 can map the provider device performance metrics 610 of the telematics metrics 618 to the inferred characteristic(s) 630 of safety-oriented 646 based on metrics indicating compliance with speed limits and safe driving behavior.

In some embodiments, the referral generation system 100 can map the provider device performance metrics 610 of the provider device safety rating 620 to the inferred characteristic(s) 630 of safety-oriented 646 based on a high safety rating signifying a consistent adherence to safety protocols and trustworthiness. For example, the referral generation system 100 can map the provider device performance metrics 610 of the provider device safety rating 620 to the inferred characteristic(s) 630 of reliable 634 based on inferring that ensuring the safety of passengers or goods indicates a strong focus on reliability.

In some embodiments, the referral generation system 100 can map the provider device performance metrics 610 of the requestor device feedback count 622 to the inferred characteristic(s) 630 of engaging 642 based on a high volume of feedback inferring that active interactions with requestors indicate a strong level of engagement. For example, the referral generation system 100 can map the provider device performance metrics 610 of the requestor device feedback count 622 to the inferred characteristic(s) 630 of motivated based on an inference that positive feedback often correlates with motivation in completing tasks beyond average expectations.

In some embodiments, the referral generation system 100 can map the provider device performance metrics 610 of the requestor device comments 624 to the inferred characteristic(s) 630 of service-oriented 636 based on specific comments highlighting quality interactions or exceptional service demonstrating a commitment to customer satisfaction. For example, the referral generation system 100 can map the provider device performance metrics 610 of the requestor device comments 624 to the inferred characteristic(s) 630 of adaptable 640 based on an inference that comments mentioning flexibility in handling unexpected situations reveal adaptability.

In some embodiments, the referral generation system 100 can map the provider device performance metrics 610 of the provider device extracurriculars 626 to the inferred characteristic(s) 630 of service-oriented 636 based on an inference that participation in extracurricular tasks or initiatives demonstrates a willingness to go beyond standard expectations. For example, the referral generation system 100 can map the provider device performance metrics 610 of the provider device extracurriculars 626 to the inferred characteristic(s) 630 of motivated 644 based on an inference that involvement in additional activities often involves a motivation to improve skills.

As further illustrated in FIG. 6, the referral generation system 100 can map the inferred characteristic(s) 630 to text 650. By mapping the inferred characteristic(s) 630 to text 650, the referral generation system 100 can generated tailored recommendations for digital third-party referral documents by aligning provider device performance metrics 610 with the text 650. In addition, based on the mapping of the provider device performance metrics 610, the referral generation system 100 can enhance the digital third-party referral documents with the provider device performance metrics 610.

To illustrate, the referral generation system 100 can map the inferred characteristic(s) 630 of responsive 632 and reliable 634 to text 652 such as “The provider has demonstrated an ability to perform time-sensitive tasks with a quick response to ride requests.” In some cases, the referral generation system 100 can map the inferred characteristic(s) 630 of service-oriented 636 and engaging 642 to text 654 such as “The provider has proven to be well-suited to assignments requiring exceptional service and client satisfaction through excellent customer service skills.” In some cases, the referral generation system 100 can map the inferred characteristic(s) 630 of engaging 642 to text 656 such as “The provider has shown a high level of engagement through regular positive interactions with clients.”

By mapping the provider device performance metrics 610 to the inferred characteristic(s) 630 and the text 650, the referral generation system 100 can implement a standardized approach, creating consistency in how provider device performance metrics 610 are interpreted and presented across different providers. This standardization also allows the referral generation system 100 to efficiently generate digital third-party referral documents and targeted opportunity recommendations tailored to specific referral objectives and/or third-party referral requests.

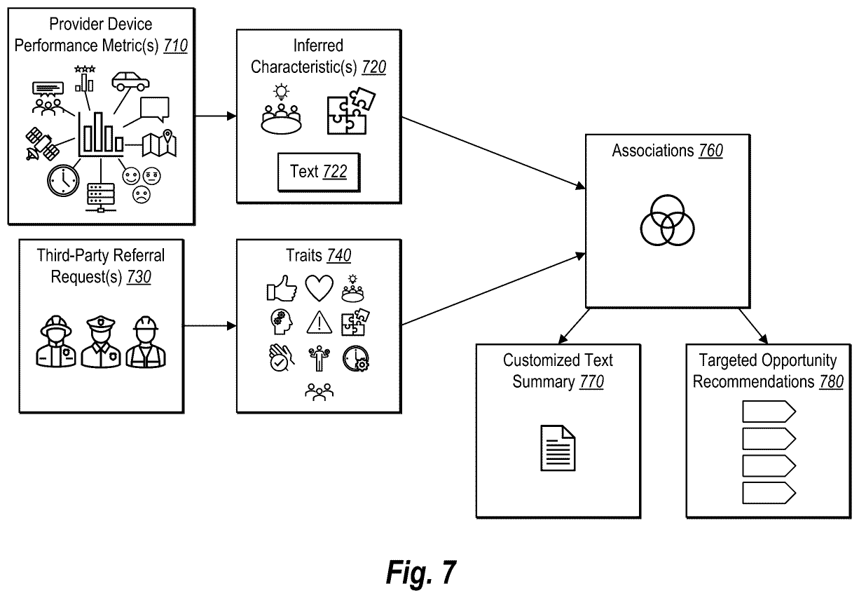

As mentioned, one or more embodiments of the referral generation system 100 utilize a heuristic generative model to generate a digital third-party referral document and/or a targeted opportunity recommendation. FIG. 7 illustrates an example of the referral generation system 100 utilizing a heuristic generative model to generate a customized text summary for a digital third-party referral document and a targeted opportunity recommendation in accordance with one or more embodiments

As shown in FIG. 7, the heuristic generative model extracts provider device performance metric(s) 710. Based on the provider device performance metric(s) 710, the heuristic generative model utilizes heuristics to map the provider device performance metric(s) 710 to inferred characteristic(s) 720 and map the inferred characteristic(s) 720 to associated text 722. For example, the heuristic generative model can utilize rule-based strategies to map the provider device performance metric(s) 710 of “transportation match count” to the inferred characteristic(s) 720 of “responsive.” Additionally, the heuristic generative model can utilize rule-based strategies to map the inferred characteristic(s) 720 of “responsive” to the associated text 722 of “The provider consistently responds quickly to requests.” In one or more embodiments, the heuristic generative model determines the inferred characteristic(s) 720 and the associated text 722 as described in relation to FIG. 6

As also shown, the heuristic generative model receives third-party referral request(s) 730. Based on the third-party referral request(s) 730, the heuristic generative model utilizes rule-based strategies to determine the traits 740. In one or more embodiments, based on the third-party referral request(s) 730, the heuristic generative model extracts the traits 740 using structured data. For example, the heuristic generative model can utilize a rule-based approach to extract traits from pre-defined fields (e.g., of the third-party referral request(s) 730). In one or more embodiments, based on the third-party referral request(s) 730, the heuristic generative model extracts the traits 740 using contextual analysis. For example, the heuristic generative model can utilize natural language processing to determine the traits 740 from unstructured or semi-structured content (e.g., of the third-party referral request(s) 730).

In one or more embodiments, the heuristic generative model determines associations 760 between the inferred characteristic(s) 720 and the traits 740. For example, the heuristic generative model determines a degree of alignment between the between the inferred characteristic(s) 720 and the traits 740. In some embodiments, heuristic generative model can assign a high alignment for strong matches and a low alignment for weak matches between the inferred characteristic(s) 720 and the traits 740. In some embodiments, the heuristic generative model utilizes a weighted scoring system to calculate alignment scores, prioritizing high-relevance matches. For example, heuristic generative model can assign a high alignment score (e.g., 8/10) for a strong match and a low alignment score (e.g., 2/10) for a weak match between the inferred characteristic(s) 720 and the traits 740.

Furthermore, in one or more embodiments, the heuristic generative model generates a customized text summary 770 based on the associations 760. For example, the heuristic generative model can generate the customized text summary 770 including a tailored narrative incorporating the associated text 722 to showcase the inferred characteristic(s) 720 that correspond to one or more of the third-party referral request(s) 730. To illustrate, the heuristic generative model can receive the provider device performance metric(s) 710 such as:
Provider Device Safety Rating: 4.8/5
Utilization Time: 94% mapped to inferred characteristic(s) 720 of:
Reliable, Safety-Oriented, Efficient mapped to associated text 722 of:
Provider showcases high safety standards with a 4.8/5 rating and outstanding reliability with a 94% utilization time.

These attributes make Provider an excellent candidate for safety-critical and reliability-focused tasks. and generate the customized text summary 770 such as:
Provider showcases high safety standards with a 4.8/5 rating and outstanding reliability with a 94% utilization time. These attributes make Provider an excellent candidate for safety-critical and reliability-focused tasks.

In some embodiments, the referral generation system 100 can utilize a comparison threshold to select the content to include within the customized text summary 770. For example, the heuristic generative model can add or remove content based on one or more of the associations 760 satisfying a threshold alignment score (or value).

Similarly, in one or more embodiments, the referral generation system 100 can generate other variations of the provider device performance metric(s) 710. For example, the heuristic generative model can generate a summary of requestor device comments. In some cases, the heuristic generative model can filter the requestor device comments based on word choice, comment tone, or comment sentiment.

As also shown in FIG. 7, in one or more embodiments, the heuristic generative model generates a targeted opportunity recommendation 780 based on the associations 760. For example, the heuristic generative model can generate the targeted opportunity recommendation 780 including selecting one or more of the third-party referral request(s) 730 based on the associations 760 between the traits 740 and the inferred characteristic(s) 720. In some cases, the heuristic generative model selects one or more of the third-party referral request(s) 730 that satisfy a threshold alignment score (or value). To illustrate, the heuristic generative model can receive the third-party referral request(s) 730 such as:
Task 1: Delivery role (e.g., traits 740 of safe and reliable)
Task 2: Customer service representative (e.g., traits 740 of efficient and engaging)
Task 3: Real estate agent (e.g., traits 740 of flexible and engaging) and generate a targeted opportunity recommendation 780 such as:
Task 1: Delivery role (e.g., inferred characteristic(s) 720 reliable, alignment score 9/10)
Task 3: Real estate agent (e.g., inferred characteristic(s) 720: adaptable, alignment score 6/10)

As mentioned, by utilizing the heuristic generative model, the referral generation system 100 generates objective outputs tailored to a specific provider by aligning the provider device performance metric(s) 710 to the specific requirements of third-party referral request(s) 730. The referral generation system 100 utilizes the heuristic generative model to ensure both the customized text summary 770 and the targeted opportunity recommendation 780 are highly relevant and personalized, yet adaptable to various contexts, such as different job roles or referral objectives. By standardizing the mapping process, the referral generation system 100 ensures consistency across providers, enabling fair and transparent evaluations. Additionally, the referral generation system 100 can dynamically adjust recommendations based on real-time data to provide the customized text summary 770 and the targeted opportunity recommendation 780.

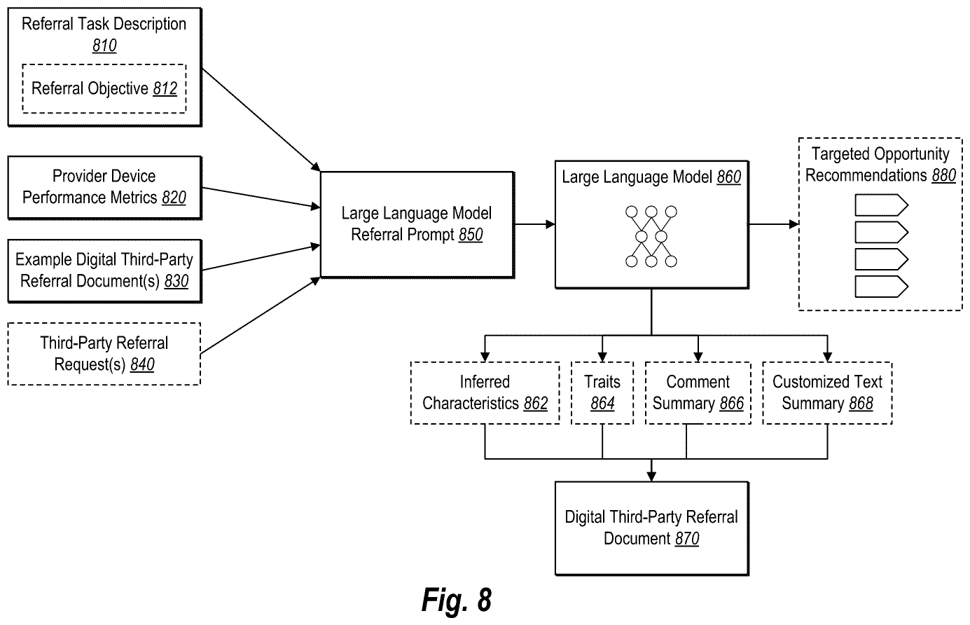

As mentioned, in one or more embodiments, the referral generation system 100 can utilize a large language model to generate a digital third-party referral document and/or a targeted opportunity recommendation. FIG. 8 illustrates an example diagram of the referral generation system 100 utilizing a large language model referral prompt to cause a large language model to generate a digital third-party referral document and/or a targeted opportunity recommendation in accordance with one or more embodiments.

As shown in FIG. 8, in some embodiments, the referral generation system 100 utilizes a large language model 860 to generate a digital third-party referral document 870 and/or a targeted opportunity recommendation 880. For example, the referral generation system 100 can generate a large language model referral prompt 850 to prompt the large language model 860 to generate the digital third-party referral document 870 and/or the targeted opportunity recommendation 880. In some embodiments, the referral generation system 100 utilizes the large language model 860 to generate inferred characteristics 862, traits 864, a comment summary 866, and/or customized text summary 868 for the provider device based on the large language model referral prompt 850.

In one or more embodiments, the referral generation system 100 generates the large language model referral prompt 850 from a referral task description 810, provider device performance metrics 820, example digital third-party referral document(s) 830, and third-party referral request(s) 840. By utilizing the large language model referral prompt 850, the referral generation system 100 guides the large language model 860 to generate a digital third-party referral document 870 with objective and consistent content (e.g., consistent content between digital third-party referral documents for multiple provider devices).

As also shown, in one or more embodiments, the referral generation system 100 utilizes the large language model referral prompt 850 to cause the large language model 860 to evaluate the provider device performance metrics 820 and the third-party referral request(s) 840 and provide the targeted opportunity recommendation 880. Through the use of the large language model referral prompt 850, the referral generation system 100 guides the large language model 860 to generate a targeted opportunity recommendation 880 tailored to characteristics exhibited by the provider as inferred from the provider device performance metrics 820.

In one or more embodiments, the referral generation system 100 utilizes a referral objective 812 to generate the large language model referral prompt 850. For example, the referral generation system 100 utilizes the referral objective 812 to generate the large language model referral prompt 850 and guide the large language model 860 to generate customized content for the digital third-party referral document 870 and/or the targeted opportunity recommendation 880. For example, the referral objective 812 can include a purpose for generating the digital third-party referral document 870 such as applying for a specific role, obtaining a loan, or meeting a requirement. To illustrate, if the referral objective 812 includes generates a digital third-party referral document 870 for a delivery job, the large language model 860 may emphasize the provider device performance metrics 820 associated with reliability, safety ratings, and punctuality. Or, if the referral objective 812 is to generate a digital third-party referral document 870 for a loan application, the large language model 860 may emphasize the provider device performance metrics 820 indicating financial responsibility or consistency. In some cases, the referral generation system 100 can utilize the referral objective 812 to guide the large language model 860 to generate targeted content for the inferred characteristics 862, the traits 864, the comment summary 866, the customized text summary 868, and/or the targeted opportunity recommendation 880.

In some cases, the referral objective 812 can include a purpose of generating the targeted opportunity recommendation 880. Based on the referral objective 812 of generating the targeted opportunity recommendation 880, the referral generation system 100 may generate the large language model referral prompt 850 and guide the large language model 860 to associate characteristics of a provider with traits of the third-party referral request(s) 840. To illustrate, the large language model referral prompt 850 may guide the large language model 860 to associate the provider device performance metrics 820 of “telematics metrics” with traits for the third-party referral request(s) 840 of “safety-focused” and “reliable.”

In certain embodiments, the referral generation system 100 utilizes the example digital third-party referral document(s) 830 to generate the large language model referral prompt 850. For example, the referral generation system 100 utilizes the example digital third-party referral document(s) 830 to generate the large language model referral prompt 850 and guide the large language model 860 to establish a baseline consistency for content, detail level, language patterns, and phrasing. Utilizing the example digital third-party referral document(s) 830, the referral generation system 100 guides the large language model 860 to generate consistent content for the inferred characteristics 862, the traits 864, the comment summary 866, the customized text summary 868, and/or the targeted opportunity recommendation 880. In this way, the referral generation system 100 can ensure uniformity of context, organization, phrasing, and style for the digital third-party referral document 870 regardless of provider specific data metrics (e.g., the provider device performance metrics 820).

In certain embodiments, the referral generation system 100 utilizes the third-party referral request(s) 840 to generate the large language model referral prompt 850. For example, the referral generation system 100 utilizes the third-party referral request(s) 840 to generate the large language model referral prompt 850 and guide the large language model 860 to generate the targeted opportunity recommendation 880 by matching the provider device performance metrics 820 with traits (e.g., qualifications, skills) required for a particular task or role associated with the third-party referral request(s) 840. In addition, the referral generation system 100 can utilize the third-party referral request(s) 840 to generate the large language model referral prompt 850 and guide the large language model 860 to tailor the digital third-party referral document 870 to match traits (e.g., qualifications, skills) required for a particular task or role associated with the third-party referral request(s) 840.

As shown in FIG. 8, in one or more embodiments, the referral generation system 100 utilizes the large language model referral prompt 850 to prompt the large language model 860 to generate the digital third-party referral document 870. For example, the referral generation system 100 can utilize a large language model referral prompt 850 similar to the following:
Generate a letter of recommendation for a Lyft provider, written from the perspective of Lyft recommending the provider as a good employee to prospective future employers. Use the provided data for context. Generate only the text of the letter, no letterhead, salutation, closing, or signature. If you are provided context about the position and company they are applying for, please emphasize their transferable skills. For example, communication and other interpersonal soft skills are relevant to an entry level office position. A provider with “tier” of “elite” is in the top 5% of Lyft providers. “Platinum” is top 15%.

As further shown in FIG. 8, the referral generation system 100 can utilize the large language model referral prompt 850 to prompt the large language model 860 to generate the inferred characteristics 862. In some embodiments, the large language model 860 utilizes the referral task description 810 to inform the large language model 860 of the referral objective 812. In some embodiments, the large language model 860 utilizes the provider device performance metrics 820 to infer characteristics for the provider. In some embodiments, the large language model 860 utilizes the example digital third-party referral document(s) 830 to provide a framework for the inferred characteristics 862. In some embodiments, the large language model 860 utilizes the third-party referral request(s) 840 as a reference for validating the inferred characteristics 862.

As shown in FIG. 8, in some embodiments, the referral generation system 100 utilizes the large language model referral prompt 850 to prompt the large language model 860 to generate the traits 864. For example, the large language model 860 utilizes natural language processing to analyze the third-party referral request(s) 840 and extract key phrases or attributes to generate the traits 864. For example, the large language model 860 can generate the traits 864 of “reliable,” “efficient,” and “adaptable” from the third-party referral request(s) 840 of “Looking for a reliable and efficient provider who can adapt to changing circumstances.”

In some embodiments, the referral generation system 100 utilizes the large language model 860 to generate the comment summary 866. In some cases, the referral generation system 100 utilizes the large language model referral prompt 850 to guide the large language model 860 to select positive requestor device comments that correspond to the referral objective 812. For example, the referral generation system 100 can utilize the large language model 860 to identify, summarize, and incorporate positive requestor device comments (e.g., from the provider device performance metrics 820) for the comment summary 866. In some cases, the referral generation system 100 utilizes the large language model referral prompt 850 to generate a customized qualitative and/or quantitative summarization of positive requestor device comments for the comment summary 866. In some cases, the referral generation system 100 utilizes the large language model referral prompt 850 to filter requestor device comments to exclude potentially sensitive data (e.g., PII) and/or profanity before incorporating the positive requestor device comments into the comment summary 866.

In some embodiments, the referral generation system 100 utilizes the large language model 860 to generate the customized text summary 868. For example, the large language model 860 integrates data from the referral task description 810, provider device performance metrics 820, example digital third-party referral document(s) 830, and/or third-party referral request(s) 840 to create a concise, purpose-driven text to showcase the characteristics that correspond to the provider device performance metrics 820. In some cases, the large language model 860 can generate the customized text summary 868 including a narrative that highlights specific characteristics, qualifications, and achievements of a provider or entity, aligned with the traits of a task associated with the third-party referral request(s) 840.

As also shown in FIG. 8, in some embodiments, the referral generation system 100 utilizes the large language model 860 to generate the targeted opportunity recommendation 880. In particular, based on the large language model referral prompt 850, the large language model 860 generates the targeted opportunity recommendation 880 including a curated list of opportunities or roles that align with the characteristics of the provider based on the provider device performance metrics 820. In some embodiments, the large language model 860 generates the targeted opportunity recommendation 880 by evaluating potential instances of the third-party referral request(s) 840 based on a degree of alignment with the provider device performance metrics 820. In some cases, the targeted opportunity recommendation 880 includes a selected third-party referral request and a brief explanation of why the provider is well-suited for the role, supported by the provider device performance metrics 820.

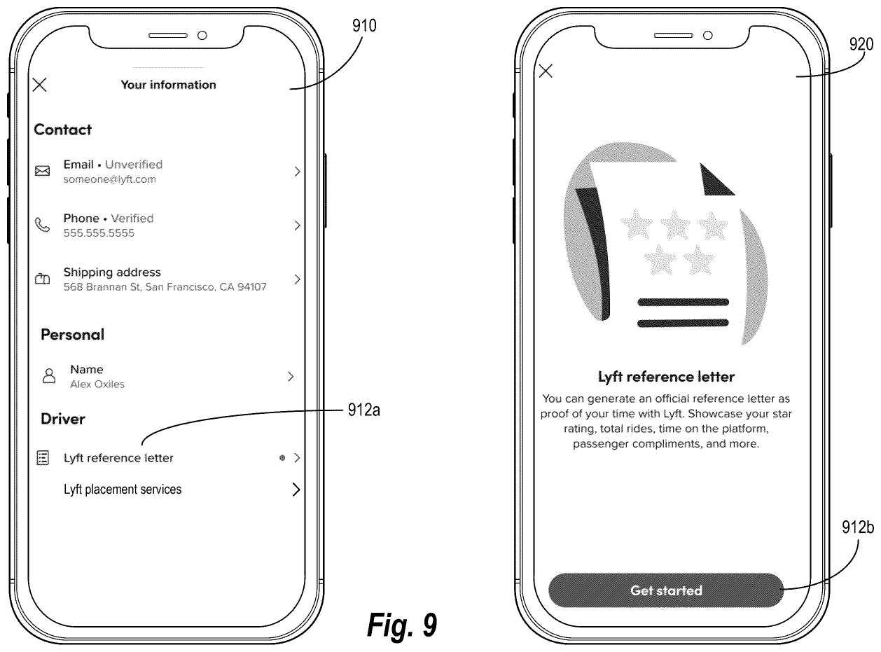

As mentioned, the referral generation system 100 can coordinate with a provider device to generate digital third-party referral documents. FIG. 9 an example of utilizing a graphical user interface of the referral generation system 100 to instigate the generation of a digital third-party referral document in accordance with one or more embodiments.

As shown in FIG. 9, in some embodiments, the referral generation system 100 can provide, for display via a provider transportation matching application of a provider device, a user interface 910 comprising a digital third-party referral request element 912a. For example, the referral generation system 100 can provide an entry point for a provider to initiate the generation of a digital third-party referral document. Based on an interaction with the digital third-party referral request element 912a, the referral generation system 100 can provide, for display via a provider transportation matching application of the provider device, additional guidance 920 for generating the digital third-party referral document.

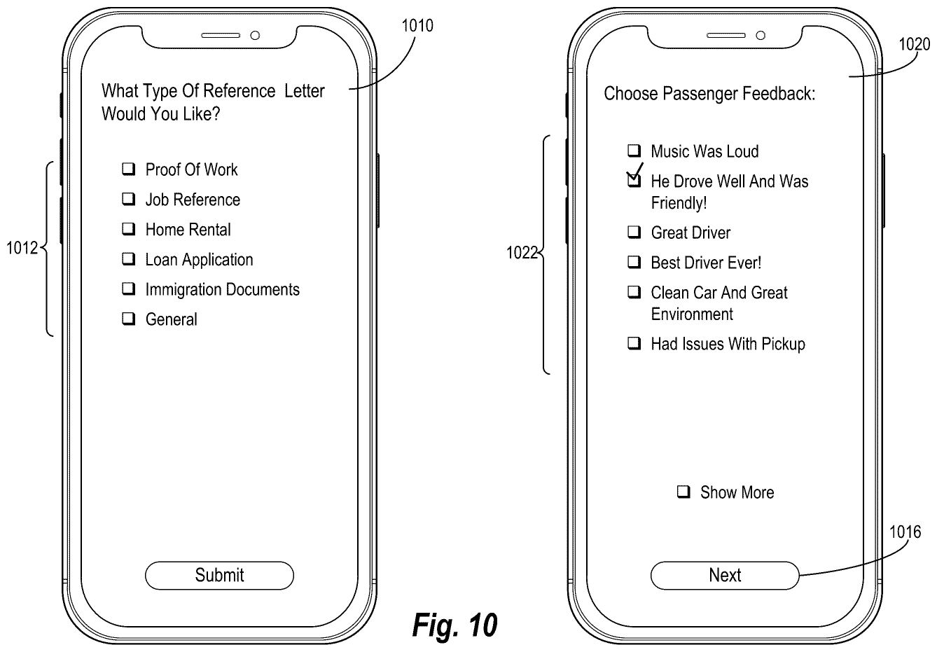

Based on an interaction with a digital third-party referral request element 912b, the referral generation system 100 can generate and/or customize a digital third-party referral document for the provider. For example, FIG. 10 an example of utilizing a graphical user interface of the referral generation system 100 to customize a digital third-party referral document in accordance with one or more embodiments.

As shown in FIG. 10, in some embodiments, the referral generation system 100 provides, for display via a provider transportation matching application of a provider device, a user interface 1010 for the provider device to select a referral objective for the digital third-party referral document. For example, the user interface 1010 can include a set of referral objectives 1012 for the digital third-party referral document. In some embodiments, the set of referral objectives 1012 include “proof of work,” “job reference,” “home rental,” “loan application,” “immigration documents,” or “general.”

As described in relation to FIGS. 1-8, the referral generation system 100 can vary the digital third-party referral document based on the set of referral objectives 1012. For example, based on a user interaction selecting a referral objective from the set of referral objectives 1012, the referral generation system 100 can extract a set of characteristics for the provider from provider device performance metrics. Furthermore, the referral generation system 100 can select one or more of the provider device performance metrics to include in the digital third-party referral document by mapping the set of characteristics for the provider to the selected referral objective (e.g., mapping to traits of the selected referral objective).

As also shown in FIG. 10, in some embodiments, the referral generation system 100 provides, for display via a provider transportation matching application of a provider device, a user interface 1020 for selecting requestor comments 1022. For example, the referral generation system 100 can identify and provide the requestor comments 1022 from the provider device performance metrics. The referral generation system 100 can provide the requestor comments 1022, or a subset of the requestor comments 1022 (e.g., positive requestor device comments, recent requestor device comments), to the provider device. The referral generation system 100 can generate the digital third-party referral document based on a selection of one or more of the comments of the requestor comments 1022.

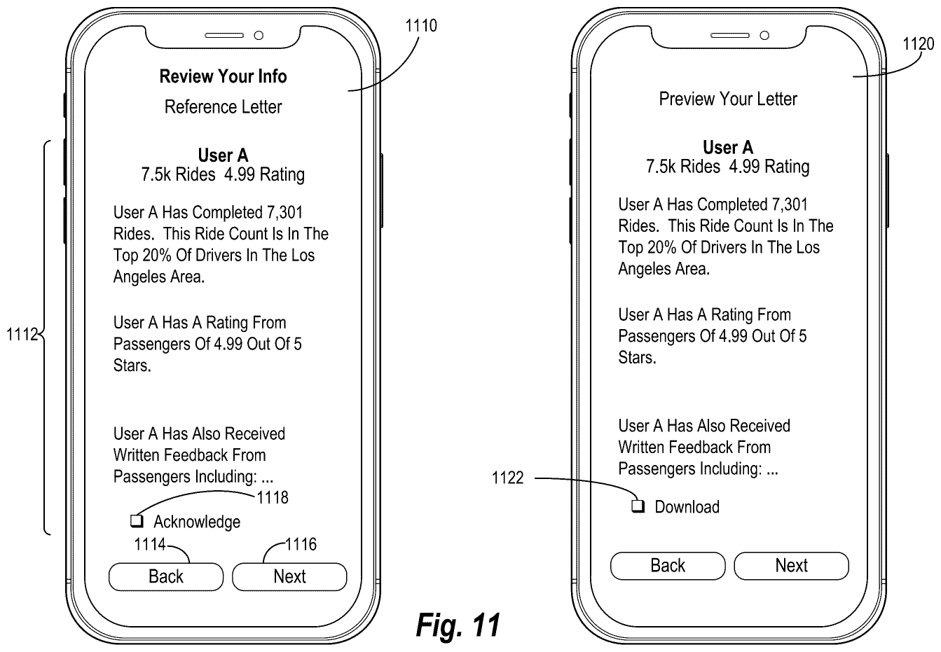

Based on an interaction with a digital third-party referral request element 1016, the referral generation system 100 can generate and/or provide a digital third-party referral document to the provider device. For example, FIG. 11 illustrates an example of utilizing a graphical user interface of the referral generation system 100 to review a digital third-party referral document in accordance with one or more embodiments.

As described in relation to FIGS. 1-8, the referral generation system 100 can provide a digital third-party referral document 1112 for display via a review screen 1110 of a provider transportation matching application of a provider device. For example, the referral generation system 100 can generate the digital third-party referral document 1112 from the provider device performance metrics. In some embodiments, the referral generation system 100 utilizes the review screen to provide an easily accessible/readable version of the digital third-party referral document 1112 for display on a mobile device (e.g., rather than utilizing a PDF format).

As also shown, the referral generation system 100 can include navigation elements to finalize the digital third-party referral document 1112. For example, the referral generation system 100 can include an acknowledgement element 1118 requiring an acknowledgement of the contents of the digital third-party referral document 1112. In some cases, the referral generation system 100 requires a selection of the acknowledgement element 1118 to ensure that the provider explicitly reviews and agrees with the contents of the digital third-party referral document 1112 before finalizing the selection and sharing the digital third-party referral document 1112 with a third-party. In this way the referral generation system 100 can safeguard the interests of the provider by ensuring an acknowledgement how the provider device performance metrics and inferred characteristics are represented in the digital third-party referral document 1112. If the provider device selects the back element 1114, the referral generation system 100 can provide options (as shown in FIG. 10) for the provider device to alter selections for the set of referral objectives 1012 and the requestor comments 1022 and recreate the digital third-party referral document 1112.

Based on an interaction with a digital third-party referral request element 1116, the referral generation system 100 can provide a standardized version of the digital third-party referral document 1120 to the provider device. Through the use of a standardized version of the digital third-party referral document 1120, the referral generation system 100 can ensure the digital third-party referral document 1120 is secure from modification (e.g., password protection), compatible for view on multiple devices, and maintains a uniform structure across all digital third-party referral documents. For example, the referral generation system 100 can provide a standardized version of the digital third-party referral document 1120 by providing a PDF of the digital third-party referral document for display via the user interface of the provider transportation matching application of the provider device.

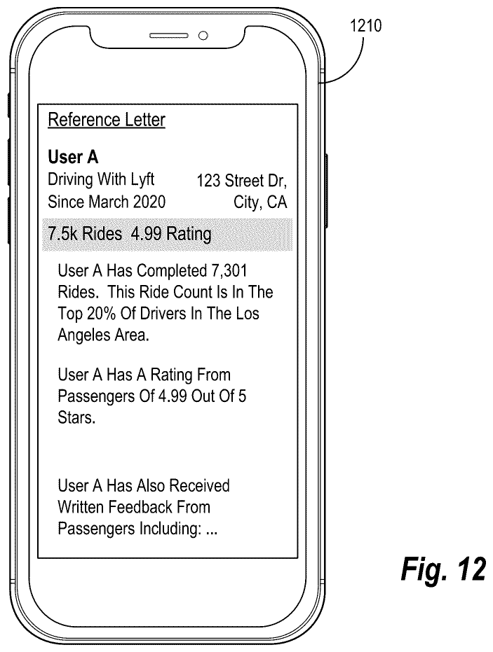

Furthermore, the referral generation system 100 can provide a download element 1122 to download the PDF of the digital third-party referral document 1120. For example, FIG. 12 illustrates an example of a PDF of a digital third-party referral document provided by the referral generation system 100 in accordance with one or more embodiments.

As illustrated in FIG. 12, the referral generation system 100 can provide the digital third-party referral document 1210 utilizing a standardized format (e.g., PDF). In particular, the referral generation system 100 can utilize the standardize format to provide the digital third-party referral document with a uniform structure for graphical elements, logos, sections, and/or signatures. As described in relation FIGS. 1-8, while the standardized format includes a uniform structure for the digital third-party referral document 1210, the specific details (e.g., inferred characteristics, customized text summary) are tailored to fit the provider and the referral objective.

In one or more embodiments, the referral generation system 100 incorporates a verification method in the digital third-party referral document 1210. For example, the referral generation system 100 can embed a unique digital identifier within the digital third-party referral document 1210. In some cases, the referral generation system 100 utilizes a digital identifier of a verification link (e.g., URL) in the digital third-party referral document 1210 (e.g., as a footer stating “Verify this document at www.referralsystem.com/verify using ID: ABC12345”). In some cases, referral generation system 100 utilizes a digital identifier of a QR code (barcode) that can be scanned to reach a digital third-party referral document verification page.

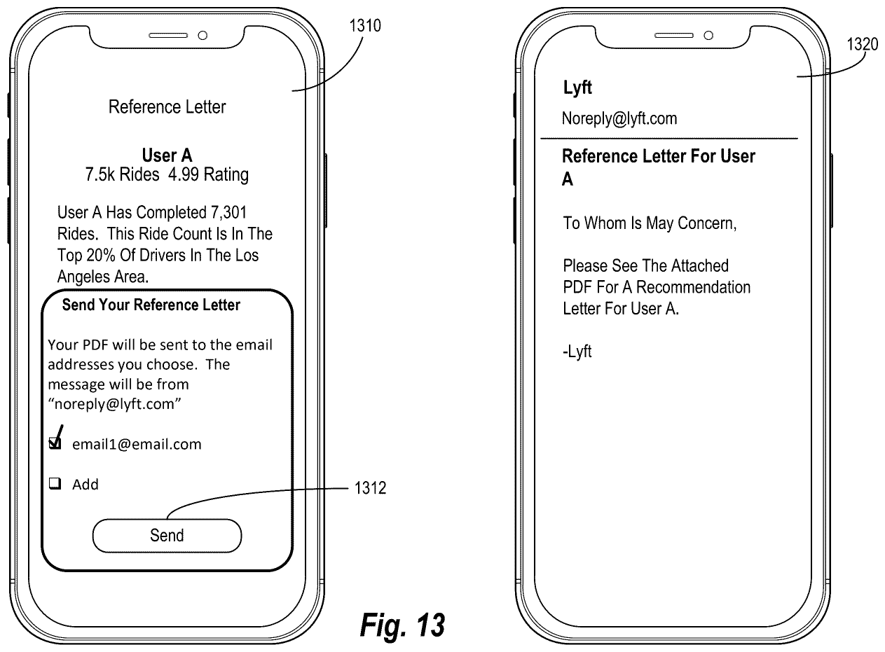

As mentioned, the referral generation system 100 can coordinate with a provider device and to provide digital third-party referral documents to a third-party device. For example, FIG. 13 illustrates an example of utilizing a graphical user interface of the referral generation system to transmit a digital third-party referral document in accordance with one or more embodiments.

As shown in FIG. 13, referral generation system 100 can transmit the digital third-party referral document 1310 to a third-party device based on a user interaction with a digital third-party referral request element 1312. For example, the referral generation system 100 can generate an email to a selected account that includes the digital third-party referral document 1310 as an attachment. In some cases, the referral generation system 100 can generate an email such as the email 1320.

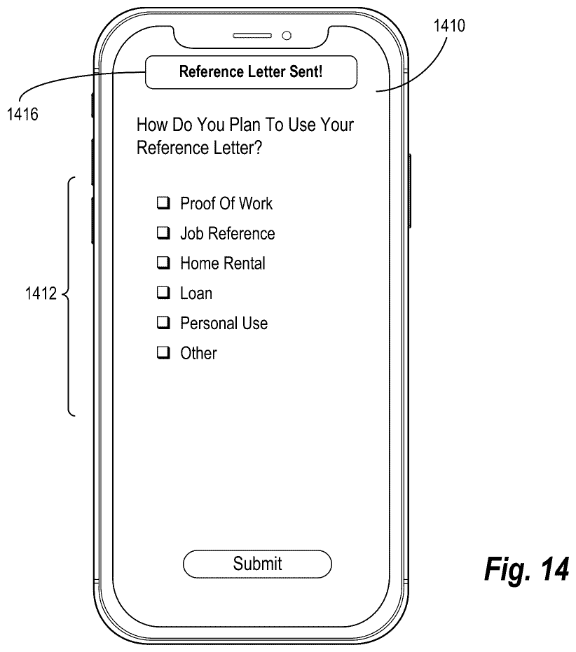

As part of generating a digital third-party referral document, the referral generation system 100 can implement features to enhance the effectiveness of the system through feedback from provider devices. For example, FIG. 14 illustrates an example of utilizing a graphical user interface of the referral generation system to collect feedback from a provider device in accordance with one or more embodiments

As shown in FIG. 14, the referral generation system 100 provides a verification element 1416 to inform the provider device that the digital third-party referral document was transmitted to the third-party device. Furthermore, the referral generation system 100 can provide a feedback interface 1410 to receive referral objectives 1412 indicating how the provider utilized the digital third-party referral document. In this way, the referral generation system 100 can track the effectiveness and useability of the digital third-party referral document and implement improvements to the referral generation system 100.

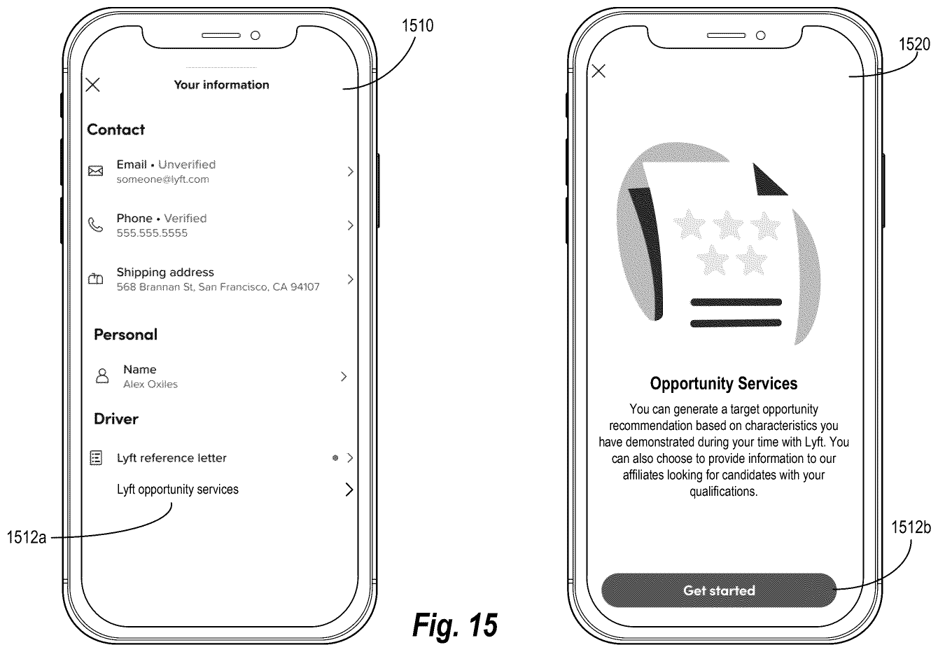

As mentioned, the referral generation system 100 can coordinate with a provider device to generate a targeted opportunity recommendation. FIG. 15 illustrates an example of utilizing a graphical user interface of the referral generation system to instigate the generation of a targeted opportunity recommendation in accordance with one or more embodiments.

As shown in FIG. 15, in some embodiments, the referral generation system 100 can provide, for display via a provider transportation matching application of a provider device, a user interface 1510 comprising a digital third-party placement recommendation element 1512a. For example, the referral generation system 100 can provide an entry point for a provider to initiate the generation of a targeted opportunity recommendation. Based on an interaction with the digital third-party placement recommendation element 1512a, the referral generation system 100 can provide, for display via a provider transportation matching application of the provider device, additional guidance 1520 for generating the targeted opportunity recommendation.

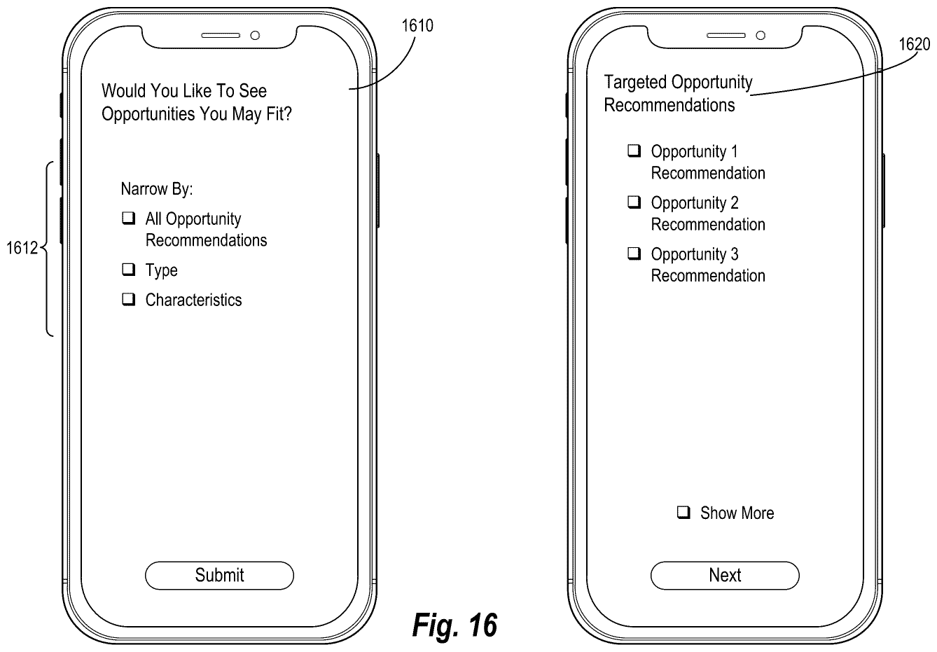

Based on an interaction with a digital third-party placement recommendation element 1512b, the referral generation system 100 can generate and/or customize a digital third-party referral document for the provider. FIG. 16 illustrates an example of utilizing a graphical user interface of the referral generation system 100 to generate a targeted opportunity recommendation in accordance with one or more embodiments.

As shown in FIG. 16, in some embodiments, the referral generation system 100 provides, for display via a provider transportation matching application of a provider device, a user interface 1610 for the provider device to request a targeted opportunity recommendation for provider. For example, the user interface 1610 can include a set of placement subsets 1612 for generating a targeted opportunity recommendation. In some embodiments, the set of placement subsets 1612 include “all placement recommendations,” “type,” or “characteristics.”

For example, based on a user interaction selecting a placement subset from the set of placement subsets 1612, the referral generation system 100 can generate a targeted opportunity recommendation 1620. As described in relation to FIGS. 1-8, the referral generation system 100 can extract a set of characteristics for the provider from provider device performance metrics. Furthermore, the referral generation system 100 can identify traits corresponding placements (e.g., third-party referral requests). The referral generation system 100 can match the provider to one or more of the placements based on associations between the traits of the third-party referral requests and the set of characteristics of the provider. As shown, the referral generation system 100 can provide the targeted opportunity recommendation 1620 for display via the provider transportation matching application of the provider device.

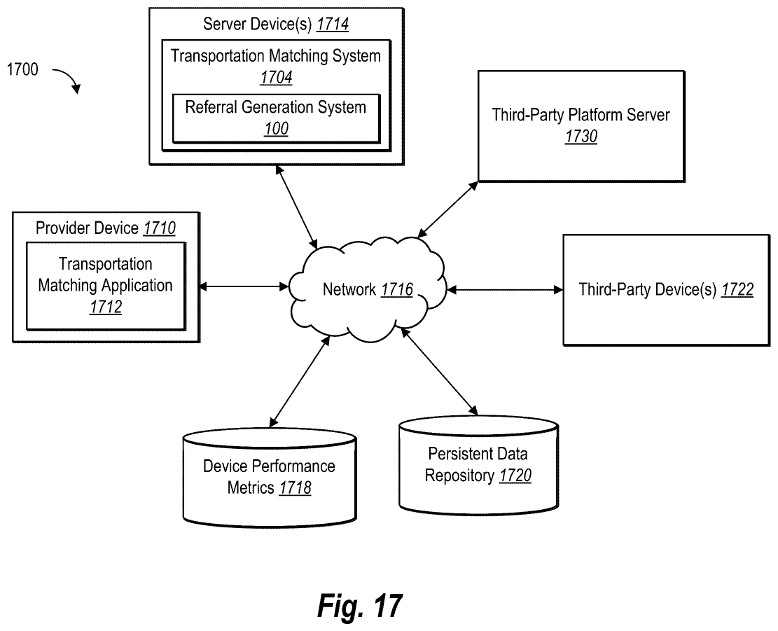

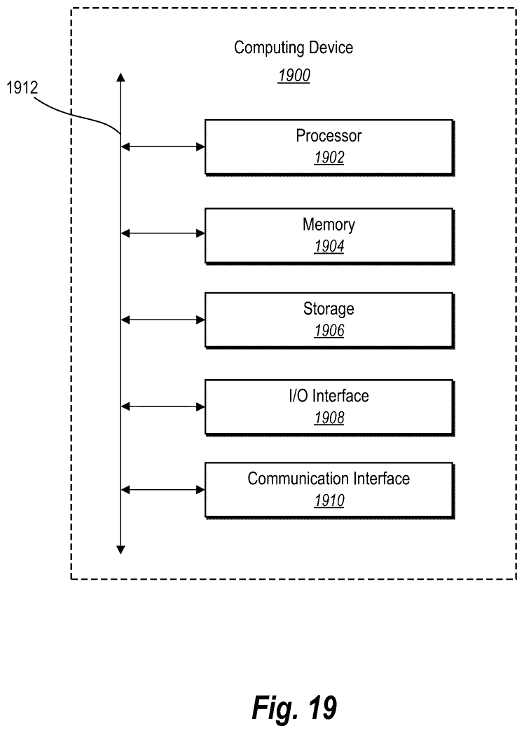

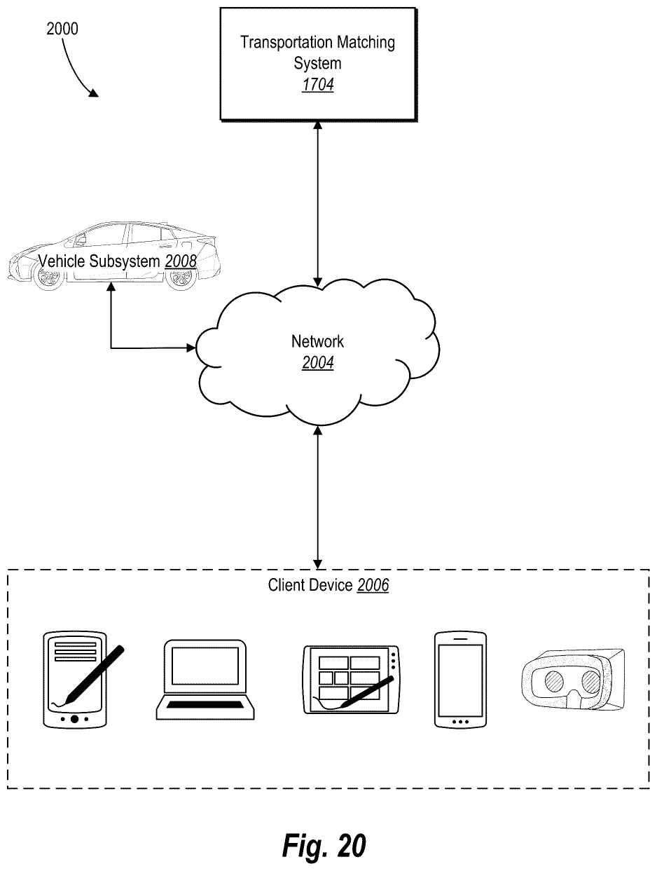

Additional detail regarding the digital notification system will now be provided with reference to the figures. In particular, FIG. 17 illustrates a block diagram of a system environment for implementing the referral generation system 100 in accordance with one or more embodiments. As shown in FIG. 17, the environment includes server device(s) 1714 housing a transportation matching system 1704. The environment of FIG. 17 further includes a provider device 1710 (including a transportation matching application 1712), a network 1716, device performance metrics 1718, third-party device(s) 1722, third-party platform server 1730, and persistent data repository 1720. The server device(s) 1714 and the provider device 1710 can include one or more computing devices to implement the referral generation system 100. Additional detail regarding the illustrated computing devices (e.g., the server device(s) 1714 and the provider device 1710) is provided with respect to FIGS. 19-20 below.

As shown, the referral generation system 100 utilizes the network 1716 to communicate with the provider device 1710. The network 1716 may comprise any network described in relation to FIGS. 19-20. For example, the referral generation system 100 communicates with the provider device 1710 to generate digital third-party referral document and/or targeted opportunity recommendation and provide for display the digital third-party referral document and/or targeted opportunity recommendation on the provider device 1710. Indeed, as already mentioned, the referral generation system 100 can receive a provider device request through the transportation matching system 1704 to generate the digital third-party referral document and/or targeted opportunity recommendation utilizing the device performance metrics 1718.

Moreover, the referral generation system 100 can receive a provider device request from a provider device 1710 and can provide a digital third-party referral document and/or targeted opportunity recommendation to the provider device 1710. In some embodiments, the transportation matching system 1704 or the referral generation system 100 receives device performance information of the device performance metrics 1718, such as a transportation match count, a utilization time, a provider device tier, telematics metrics, a provider device safety rating, a requestor device feedback count, requestor device comments, and provider device extracurriculars.

Additionally, the referral generation system 100 can receive a third-party referral request from the third-party device(s) 1722 and can provide a digital third-party referral document, a referral verification, and/or provider placement map to the third-party device(s) 1722. In some embodiments, the transportation matching system 1704 or the referral generation system 100 receives referral opportunities or third-party verification requests from the third-party device(s) 1722.

Furthermore, the referral generation system 100 can utilize the device performance metrics 1718 to determine additional metrics (e.g., additional provider device performance metrics) for a specific geographic region. Specifically, based on the device performance metrics 1718, including the additional metrics, the referral generation system 100 can generate the digital third-party referral document and/or targeted opportunity recommendation for display the nearby provider devices via the transportation matching application 1712.

In one or more embodiments, the device performance metrics 1718 include or refer to measurable data points from operational data captured during the fulfillment of transportation requests. For example, the transportation matching system 1704 can generate the device performance metrics 1718 by collecting and compiling real-time and/or historical data into a structured format. In some embodiments, the device performance metrics 1718 include metrics comparing provider devices with additional provider devices in a geographic region shared between the provider devices and the additional provider devices (e.g., operating under similar transportation constraints associated with a geographic region).

In one or more embodiments, the referral generation system 100 can communicate with a third-party platform server 1730 to receive performance data to generate one or more of the device performance metrics 1718. For example, the referral generation system 100 can utilize APIs, or alternative data integration methods, to send structured requests to the third-party platform server 1730 to obtain performance data. The third-party platform server 1730 can process the request and respond with the requested performance data in a predefined format, such as JSON or XML. In some embodiments, the referral generation system 100 can retrieve performance data via alternate methods such as batch file uploads or direct database access from the third-party platform server 1730. Based on the retrieved performance data, the referral generation system 100 can parse, validate, combine, and/or integrate the performance data retrieved from the third-party platform server 1730 into the device performance metrics 1718.

Additionally, the referral generation system 100 can utilize the persistent data repository 1720 to maintain content for multiple digital third-party referral documents, provider placement map, and/or targeted opportunity recommendation. For example, the referral generation system 100 can maintain content for multiple digital third-party referral documents associated with the provider device with different content, different timestamps, and/or different customization. In some cases, the referral generation system 100 can maintain content for multiple targeted opportunity recommendations associated with the provider device with different content and different timestamps. Furthermore, the referral generation system 100 can cause a graphical user interface of the provider device 1710 to display the digital third-party referral document and/or the targeted opportunity recommendation.

To facilitate providing digital third-party referral documents and/or targeted opportunity recommendations to client devices, in some embodiments, the referral generation system 100 communicates with the provider device 1710, third-party device(s) 1722, and other client devices connected to the transportation matching system 1704. As indicated by FIG. 17, the provider device 1710 includes the transportation matching application 1712. In many embodiments, the referral generation system 100 communicates with the provider device 1710 through the transportation matching application 1712 to, for example, generate digital third-party referral documents and/or targeted opportunity recommendations to provide within a graphical user interface of the transportation matching application 1712.

As indicated above, the referral generation system 100 can provide (and/or cause the provider device 1710 to display or render) visual elements within the graphical user interface associated with the transportation matching application 1712. For example, the referral generation system 100 can provide a digital third-party referral document and/or targeted opportunity recommendation for display within the transportation matching application 1712.

Moreover, the referral generation system 100 provides a user interface via the provider device 1710 that includes selectable options for providing the digital third-party referral document and/or targeted opportunity recommendation through the transportation matching application 1712 based on various referral objectives (e.g., task, context, purpose, position, or assignment), device performance metrics 1718, and user device selections. The referral generation system 100 can provide a user interface for provider devices to interact with the referral generation system 100 (e.g., through interaction with the transportation matching application 1712).

Although FIG. 17 illustrates the environment having a particular number and arrangement of components associated with the referral generation system 100, in some embodiments, the environment may include more or fewer components with varying configurations. For example, in some embodiments, the referral generation system 100 can communicate directly with the provider device 1710, bypassing the network 1716. In these or other embodiments, the referral generation system 100 can be housed (entirely on in part) on the provider device 1710. Additionally, the referral generation system 100 can include or communicate with a database for storing information, such as various machine learning models, historical data (e.g., historical provider device performance metrics), transportation requests, and/or other information described herein. Moreover, although FIG. 17 illustrates a single instance of the provider device 1710, the provider device 1710 is representative of a variety of client devices (e.g., thousands or millions of provider devices) that interact with the referral generation system 100, and/or the transportation matching system 1704.

Moreover, although not shown, the environment 1700 further includes thousands or millions of requestor devices interacting with the transportation matching system 1704. In particular, the referral generation system 100 utilizes the data from the provider devices interacting with the transportation matching system 1704 to store it within the device performance metrics 1718. For instance, the data of the provider devices can include location data, recent pickups, cancelled requests, requestor device feedback, etc.

The components of the referral generation system 100 can include software, hardware, or both. For example, the components of the referral generation system 100 can include one or more instructions stored on a computer-readable storage medium and executable by processors of one or more computing devices. When executed by the one or more processors, the computer-executable instructions of the referral generation system 100 can cause the computing device to perform the methods described herein. Alternatively, the components of the referral generation system 100 can comprise hardware, such as a special purpose processing device to perform a certain function or group of functions. Additionally, or alternatively, the components of the referral generation system 100 can include a combination of computer-executable instructions and hardware.

Furthermore, the components of the referral generation system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the referral generation system 100 may be implemented as part of a stand-alone application on a personal computing device or a mobile device. Alternatively, or additionally, the components of the referral generation system 100 may be implemented in any application that generates and provides notifications, but not limited to, various applications.

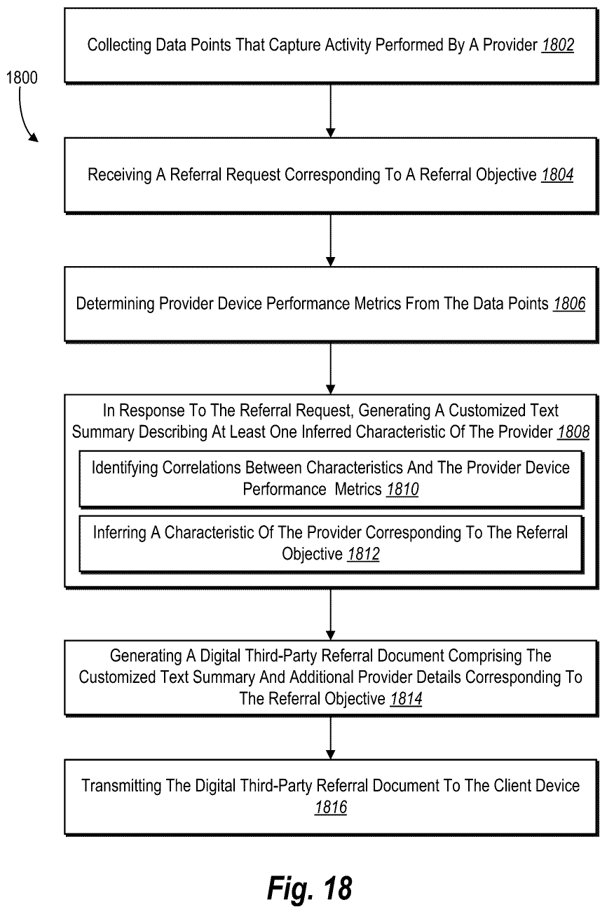

FIGS. 1-17, the corresponding text, and the examples provide a number of different systems, methods, and non-transitory computer readable media for generating and providing digital third-party referral documents and/or targeted opportunity recommendations. In addition to the foregoing, embodiments can also be described in terms of flowcharts comprising acts for accomplishing a particular result. For example, FIG. 18 illustrates a flowchart of an example sequence of acts in accordance with one or more embodiments.

While FIG. 18 illustrates acts according to some embodiments, alternative embodiments may omit, add to, reorder, and/or modify any of the acts shown in FIG. 18. The acts of FIG. 18 can be performed as part of a method. Alternatively, a non-transitory computer readable medium can comprise instructions, that when executed by one or more processors, cause a computing device to perform the acts of FIG. 18. In still further embodiments, a system can perform the acts of FIG. 18. Additionally, the acts described herein may be repeated or performed in parallel with one another or in parallel with different instances of the same or other similar acts.

FIG. 18 illustrates an example series of acts 1800 to utilize a generative model to generate a digital third-party referral document that incorporates a customized text summary reflecting characteristics inferred from provider device performance metrics for display. As shown, the series of acts 1800 includes an act 1802 of collecting data points that capture activity performed by a provider. In one or more implementations, the act 1802 further includes collecting data points that capture activity performed by a provider associated with transportation requests fulfilled by a provider device. In one or more embodiments, the series of acts 1800 includes an act 1804 of receiving a referral request corresponding to a referral objective. In particular, the act 1804 further includes receiving a referral request corresponding to a referral objective based on a user interaction with a digital third-party referral request element via a client device. In certain embodiments, the series of acts 1800 includes an act 1806 of determining provider device performance metrics from the data points.

In some embodiments, the series of acts 1800 includes an act 1808 of, in response to the referral request, generating a customized text summary describing at least one inferred characteristic of the provider. In certain cases, the act 1808 further includes the sub-act 1810 of identifying correlations between characteristics and the provider device performance metrics and the sub-act 1812 of inferring a characteristic of the provider corresponding to the referral objective. In particular, the act 1808 includes in response to the referral request, generating a customized text summary describing at least one inferred characteristic of the provider by analyzing the determined provider device performance metrics to identify correlations between characteristics and the provider device performance metrics and inferring, based on the correlations, at least one characteristic of the provider corresponding to the referral objective.

In some embodiments, the series of acts 1800 includes an act 1814 of generating a digital third-party referral document comprising the customized text summary and additional provider details corresponding to the referral objective. In certain cases, the series of acts 1816 includes transmitting the digital third-party referral document to the client device. In particular, the series of acts 1816 includes transmitting the digital third-party referral document to the client device for display via a user interface of the client device.

In one or more implementations, the series of acts 1800 includes generating the customized text summary by mapping a first provider device performance metric to a first characteristic corresponding to the provider. Further, in one or more implementations, the series of acts 1800 includes generating the customized text summary utilizing a generative heuristic model by mapping the first characteristic of the provider to a text description. In one or more embodiments, the series of acts 1800 includes generating the customized text summary utilizing a generative heuristic model by adding the text description to the customized text summary.

Furthermore, the series of acts 1800 includes generating a large language model referral prompt comprising a referral task description, the provider device performance metrics, and an example digital third-part referral document. In one or more embodiments, the series of acts 1800 includes generating, utilizing a large language model, the digital third-party referral document from the large language model referral prompt.

Furthermore, the series of acts 1800 includes determining a set of traits associated with a third-party referral request received from a third-party device. In one or more embodiments, the series of acts 1800 includes generating a targeted opportunity recommendation comprising the third-party referral request based on at least one association between the provider device performance metrics and the set of traits. Furthermore, the series of acts 1800 includes providing, for display via a provider transportation matching application of the provider device associated with the provider, the targeted opportunity recommendation. In one or more embodiments, the series of acts 1800 includes selecting the additional provider details corresponding to the referral objective based on the correlations between the characteristics and the provider device performance metrics, wherein the additional provider details comprise one or more of the determined provider device performance metrics.

In one or more embodiments, the series of acts 1800 includes, in response to a user interaction via the client device approving the digital third-party referral document, transmitting the digital third-party referral document to a third-party device. Furthermore, the series of acts 1800 includes generating a persistent data repository comprising a referral identifier for the digital third-party referral document and further comprising data points reflecting contents of the digital third-party referral document. In one or more embodiments, the series of acts 1800 includes, in response to receiving a query comprising the referral identifier, generating a query response by accessing the data points reflecting the contents of the digital third-party referral document from the persistent data repository.

Furthermore, the series of acts 1800 includes generating the digital third-party referral document to include a digital identifier. In one or more embodiments, the series of acts 1800 includes, in response to receiving the digital identifier from a third-party device, utilizing the digital identifier to verify the digital third-party referral document for the third-party device. Furthermore, the series of acts 1800 includes transmitting a digital verification of the digital third-party referral document to the third-party device.

Furthermore, the series of acts 1800 includes identifying digital requestor device comments corresponding to the provider device. In one or more embodiments, the series of acts 1800 includes selecting a subset of the digital requestor device comments. In one or more embodiments, the series of acts 1800 includes generating the digital third-party referral document from the subset of the digital requestor device comments. Furthermore, the series of acts 1800 includes determining the provider device performance metrics from the data points comprising determining at least one of a transportation match count, a utilization time, a provider device tier, telematics metrics, a provider device safety rating, a requestor device feedback count, requestor device comments, or a provider device extracurricular.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 19 illustrates, in block diagram form, an exemplary instance of the computing device 1900 (e.g., the provider device 1710, or the server device(s) 1714) that may be configured to perform one or more of the processes described above. One will appreciate that the referral generation system 100 can comprise implementations of the computing device 1900, including, but not limited to, the provider device 1710, or the server device(s) 1714. As shown by FIG. 19, the computing device can comprise a processor(s) 1902, memory 1904, a storage device 1906, an I/O interface 1908, and a communication interface 1910. In certain embodiments, the computing device 1900 can include fewer or more components than those shown in FIG. 19. Components of computing device 1900 shown in FIG. 19 will now be described in additional detail.

In particular embodiments, processor(s) 1902 includes hardware for executing instructions, such as those making up a computer program. As an example, and not by way of limitation, to execute instructions, processor(s) 1902 may retrieve (or fetch) the instructions from an internal register, an internal cache, memory 1904, or a storage device 1906 and decode and execute them.

The computing device 1900 includes memory 1904, which is coupled to the processor(s) 1902. The memory 1904 may be used for storing data, metadata, and programs for execution by the processor(s). The memory 1904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1904 may be internal or distributed memory.

The computing device 1900 includes a storage device 1906 includes storage for storing data or instructions. As an example, and not by way of limitation, storage device 1906 can comprise a non-transitory storage medium described above. The storage device 1906 may include a hard disk drive (“HDD”), flash memory, a Universal Serial Bus (“USB”) drive or a combination of these or other storage devices.

The computing device 1900 also includes one or more input or I/O interface 1908 (or “input or output interface”), which are provided to allow a user (e.g., requestor or provider) to provide input to (such as user strokes), receive output from, and otherwise transfer data to and from the computing device 1900. These I/O interface 1908 may include a mouse, keypad or a keyboard, a touch screen, camera, optical scanner, network interface, modem, other known I/O devices or a combination of such I/O interface 1908. The touch screen may be activated with a stylus or a finger.

The I/O interface 1908 may include one or more devices for presenting output to a user, including, but not limited to, a graphics engine, a display (e.g., a display screen), one or more output providers (e.g., display providers), one or more audio speakers, and one or more audio providers. In certain embodiments, I/O interface 1908 is configured to provide graphical data to a display for presentation to a user. The graphical data may be representative of one or more graphical user interfaces and/or any other graphical content as may serve a particular implementation.

The computing device 1900 can further include a communication interface 1910. The communication interface 1910 can include hardware, software, or both. The communication interface 1910 can provide one or more interfaces for communication (such as, for example, packet-based communication) between the computing device and one or more other instances of the computing device 1900 or one or more networks. As an example, and not by way of limitation, communication interface 1910 may include a network interface controller (“NIC”) or network adapter for communicating with an Ethernet or other wire-based network or a wireless NIC (“WNIC”) or wireless adapter for communicating with a wireless network, such as a WI-FI. The computing device 1900 can further include a bus 1912. The bus 1912 can comprise hardware, software, or both that connects components of computing device 1900 to each other.

FIG. 20 illustrates an example network environment 2000 of the transportation matching system 1704. The network environment 2000 includes a client device 2006 (e.g., a provider device, a requestor device, additional the client device, or an infotainment device), a transportation matching system 1704, and a vehicle subsystem 2008 connected to each other by a network 2004. Although FIG. 20 illustrates a particular arrangement of the client device 2006, the transportation matching system 1704, the vehicle subsystem 2008, and the network 2004, this disclosure contemplates any suitable arrangement of client device 2006, the transportation matching system 1704, the vehicle subsystem 2008, and the network 2004. As an example, and not by way of limitation, two or more of client device 2006, the transportation matching system 1704, and the vehicle subsystem 2008 communicate directly, bypassing the network 2004. As another example, two or more of client device 2006, the transportation matching system 1704, and the vehicle subsystem 2008 may be physically or logically co-located with each other in whole or in part.

Moreover, although FIG. 20 illustrates a particular number of the client device 2006, transportation matching system 1704, vehicle subsystems 2008, and network 2004, this disclosure contemplates any suitable number of the client device 2006, transportation matching system 1704, vehicle subsystems 2008, and network 2004. As an example, and not by way of limitation, network environment 2000 may include multiple instances of the client device 2006, transportation matching system 1704, vehicle subsystems 2008, and/or network 2004.

This disclosure contemplates any suitable network for the network 2004. As an example, and not by way of limitation, one or more portions of network 2004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 2004 may include one or more of the network 2004.

Links may connect client device 2006, referral generation system 100, and vehicle subsystem 2008 to network 2004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 2000. One or more first links may differ in one or more respects from one or more second links.

In particular embodiments, the client device 2006 may be an electronic device including hardware, software, or embedded logic components or a combination of two or more such components and capable of carrying out the appropriate functionalities implemented or supported by client device 2006. As an example, and not by way of limitation, a client device 2006 may include any of the computing devices discussed above in relation to FIG. 19. A client device 2006 may enable a network user at the client device 2006 to access the network 2004. A client device 2006 may enable its user to communicate with other users at other instances of the client device 2006.

In particular embodiments, the client device 2006 may include a requestor application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 2006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 2006 one or more Hyper Text Markup Language (“HTML”) files responsive to the HTTP request. The client device 2006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 1704 may be a network-addressable computing system that can host a transportation matching network. The transportation matching system 1704 may generate, store, receive, and send data, such as, for example, user-profile data, concept-profile data, text data, transportation request data, GPS location data, provider data, requestor data, vehicle data, or other suitable data related to the transportation matching network. This may include authenticating the identity of providers and/or vehicles who are authorized to provide transportation services through the transportation matching system 1704. In addition, the transportation matching system 1704 may manage identities of service requestors such as users/requestors. In particular, the transportation matching system 1704 may maintain requestor data such as driving/riding histories, personal data, or other user data in addition to navigation and/or traffic management services or other location services (e.g., GPS services).

In particular embodiments, the transportation matching system 1704 may manage transportation matching services to connect a user/requestor with a vehicle and/or provider. By managing the transportation matching services, the transportation matching system 1704 can manage the distribution and allocation of resources from vehicle systems and user resources such as GPS location and availability indicators, as described herein.

The transportation matching system 1704 may be accessed by the other components of network environment 2000 either directly or via network 2004. In particular embodiments, the transportation matching system 1704 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 1704 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 2006, or a transportation matching system 1704 to manage, retrieve, modify, add, or delete, the information stored in data store.

In particular embodiments, the transportation matching system 1704 may provide users with the ability to take actions on various types of items or objects, supported by the transportation matching system 1704. As an example, and not by way of limitation, the items and objects may include transportation matching networks to which users of the transportation matching system 1704 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 1704 or by an external system of a third-party system, which is separate from transportation matching system 1704 and coupled to the transportation matching system 1704 via a network 2004.

In particular embodiments, the transportation matching system 1704 may be capable of linking a variety of entities. As an example, and not by way of limitation, the transportation matching system 1704 may enable users to interact with each other or other entities, or to allow users to interact with these entities through an application programming interfaces (“API”) or other communication channels.

In particular embodiments, the transportation matching system 1704 may include a variety of servers, sub-systems, programs, modules, logs, and data stores. In particular embodiments, the transportation matching system 1704 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requestor profile) store, connection store, third-party content store, or location store. The transportation matching system 1704 may also include suitable components such as network interfaces, security mechanisms, load balancers, failover servers, management-and-network-operations consoles, other suitable components, or any suitable combination thereof. In particular embodiments, the transportation matching system 1704 may include one or more user-profile stores for storing user profiles for transportation providers and/or transportation requestors. A user profile may include, for example, biographic information, demographic information, behavioral information, social information, or other types of descriptive information, such as interests, affinities, or location.

The web server may include a mail server or other messaging functionality for receiving and routing messages between the transportation matching system 1704 and one or more of the client device 2006. An action logger may be used to receive communications from a web server about a user's actions on or off the transportation matching system 1704. In conjunction with the action log, a third-party-content-object log may be maintained of user exposures to third-party-content objects. A notification controller may provide information regarding content objects to a client device 2006. Information may be pushed to a client device 2006 as notifications, or information may be pulled from client device 2006 responsive to a request received from client device 2006. Authorization servers may be used to enforce one or more privacy settings of the users of the transportation matching system 1704. A privacy setting of a user determines how particular information associated with a user can be shared. The authorization server may allow users to opt in to or opt out of having their actions logged by the transportation matching system 1704 or shared with other systems, such as, for example, by setting appropriate privacy settings. Third-party-content-object stores may be used to store content objects received from third parties. Location stores may be used for storing location information received from one or more of the client device 2006 associated with users.

In addition, the vehicle subsystem 2008 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 2008 can include an autonomous vehicle—e.g., a vehicle that does not require a human operator. In these embodiments, the vehicle subsystem 2008 can perform maneuvers, communicate, and otherwise function without the aid of a human provider, in accordance with available technology.

In particular embodiments, the vehicle subsystem 2008 may include one or more sensors incorporated therein or associated thereto. For example, sensor(s) can be mounted on the top of the vehicle subsystem 2008 or else can be located within the interior of the vehicle subsystem 2008. In certain embodiments, the sensor(s) can be located in multiple areas at once—e.g., split up throughout the vehicle subsystem 2008 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requestor.

In particular embodiments, the vehicle subsystem 2008 may include a communication device capable of communicating with the client device 2006 and/or the referral generation system 100. For example, the vehicle subsystem 2008 can include an on-board computing device communicatively linked to the network 2004 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
collecting data points that capture activity performed by a provider associated with transportation requests fulfilled by a provider device;
receiving a referral request corresponding to a referral objective based on a user interaction with a digital third-party referral request element via a client device;
determining provider device performance metrics from the data points;
in response to the referral request, generating a customized text summary describing at least one inferred characteristic of the provider by:
analyzing the determined provider device performance metrics to identify correlations between characteristics and the provider device performance metrics; and
inferring, based on the correlations, at least one characteristic of the provider corresponding to the referral objective;
generating a digital third-party referral document comprising the customized text summary and additional provider details corresponding to the referral objective; and
transmitting the digital third-party referral document to the client device for display via a user interface of the client device.

2. The computer-implemented method of claim 1, further comprising generating the customized text summary by:
mapping a first provider device performance metric to a first characteristic corresponding to the provider;
mapping the first characteristic of the provider to a text description; and
adding the text description to the customized text summary.

3. The computer-implemented method of claim 1, further comprising generating the digital third-party referral document by:
generating a large language model referral prompt comprising a referral task description, the provider device performance metrics, and an example digital third-part referral document; and
generating, utilizing a large language model, the digital third-party referral document from the large language model referral prompt.

4. The computer-implemented method of claim 1, further comprising:
determining a set of traits associated with a third-party referral request received from a third-party device;
generating a targeted opportunity recommendation comprising the third-party referral request based on at least one association between the provider device performance metrics and the set of traits; and
providing, for display via a provider transportation matching application of the provider device associated with the provider, the targeted opportunity recommendation.

5. The computer-implemented method of claim 1, further comprising generating the digital third-party referral document by selecting the additional provider details corresponding to the referral objective based on the correlations between the characteristics and the provider device performance metrics, wherein the additional provider details comprise one or more of the determined provider device performance metrics.

6. The computer-implemented method of claim 1, further comprising, in response to a user interaction via the client device approving the digital third-party referral document, transmitting the digital third-party referral document to a third-party device.

7. The computer-implemented method of claim 1, further comprising:
generating a persistent data repository comprising a referral identifier for the digital third-party referral document and further comprising data points reflecting contents of the digital third-party referral document; and
in response to receiving a query comprising the referral identifier, generating a query response by accessing the data points reflecting the contents of the digital third-party referral document from the persistent data repository.

8. The computer-implemented method of claim 1, further comprising:
generating the digital third-party referral document to include a digital identifier;
in response to receiving the digital identifier from a third-party device, utilizing the digital identifier to verify the digital third-party referral document for the third-party device; and
transmitting a digital verification of the digital third-party referral document to the third-party device.

9. The computer-implemented method of claim 1, generating the digital third-party referral document by:
identifying digital requestor device comments corresponding to the provider device;
selecting a subset of the digital requestor device comments; and
generating the digital third-party referral document from the subset of the digital requestor device comments.

10. The computer-implemented method of claim 1, wherein determining the provider device performance metrics from the data points comprises determining at least one of a transportation match count, a utilization time, a provider device tier, telematics metrics, a provider device safety rating, a requestor device feedback count, requestor device comments, or a provider device extracurricular.

11. A system comprising:
at least one processor; and
a non-transitory computer-readable medium comprising instructions that, when executed by the at least one processor, to cause the system to:
collect data points that capture activity performed by a provider associated with transportation requests fulfilled by a provider device;
receive a referral request corresponding to a referral objective based on a user interaction with a digital third-party referral request element via a client device;
determine provider device performance metrics from the data points;
in response to the referral request, generate a customized text summary describing at least one inferred characteristic of the provider by:
analyze the determined provider device performance metrics to identify correlations between characteristics and the provider device performance metrics; and
infer, based on the correlations, at least one characteristic of the provider corresponding to the referral objective;
generate a digital third-party referral document comprising the customized text summary and additional provider details corresponding to the referral objective; and
transmit the digital third-party referral document to the client device for display via a user interface of the client device.

12. The system of claim 11, further comprising generating the customized text summary by:
mapping a first provider device performance metric to a first characteristic corresponding to the provider;
mapping the first characteristic of the provider to a text description; and
adding the text description to the customized text summary.

13. The system of claim 11, further comprising generating the digital third-party referral document by:
generating a large language model referral prompt comprising a referral task description, the provider device performance metrics, and an example digital third-part referral document; and
generating, utilizing a large language model, the digital third-party referral document from the large language model referral prompt.

14. The system of claim 11, further comprising instructions that, when executed by the at least one processor, to cause the system to:
determine a set of traits associated with a third-party referral request received from a third-party device;
generate a targeted opportunity recommendation comprising the third-party referral request based on at least one association between the provider device performance metrics and the set of traits; and
provide, for display via a provider transportation matching application of the provider device associated with the provider, the targeted opportunity recommendation.

15. The system of claim 11, further comprising generating the digital third-party referral document by selecting the additional provider details corresponding to the referral objective based on the correlations between the characteristics and the provider device performance metrics, wherein the additional provider details comprise one or more of the determined provider device performance metrics.

16. The system of claim 11, further comprising instructions that, when executed by the at least one processor, to cause the system to:
generate the digital third-party referral document to include a digital identifier;
in response to receiving the digital identifier from a third-party device, utilize the digital identifier to verify the digital third-party referral document for the third-party device; and
transmit a digital verification of the digital third-party referral document to the third-party device.

17. A non-transitory computer-readable medium storing instructions that, when executed by at least one processor, cause a computing device to:
collect data points that capture activity performed by a provider associated with transportation requests fulfilled by a provider device;
receive a referral request corresponding to a referral objective based on a user interaction with a digital third-party referral request element via a client device;
determine provider device performance metrics from the data points;
in response to the referral request, generate a customized text summary describing at least one inferred characteristic of the provider by:
analyze the determined provider device performance metrics to identify correlations between characteristics and the provider device performance metrics; and
infer, based on the correlations, at least one characteristic of the provider corresponding to the referral objective;
generate a digital third-party referral document comprising the customized text summary and additional provider details corresponding to the referral objective; and
transmit the digital third-party referral document to the client device for display via a user interface of the client device.

18. The non-transitory computer-readable medium of claim 17, further comprising generating the customized text summary by:
mapping a first provider device performance metric to a first characteristic corresponding to the provider;
mapping the first characteristic of the provider to a text description; and
adding the text description to the customized text summary.

19. The non-transitory computer-readable medium of claim 17, further comprising generating the digital third-party referral document by:
generating a large language model referral prompt comprising a referral task description, the provider device performance metrics, and an example digital third-part referral document; and
generating, utilizing a large language model, the digital third-party referral document from the large language model referral prompt.

20. The non-transitory computer-readable medium of claim 17, further comprising instructions that, when executed by the at least one processor, cause the computing device to:
determining a set of traits associated with a third-party referral request received from a third-party device;
generating a targeted opportunity recommendation comprising the third-party referral request based on at least one association between the provider device performance metrics and the set of traits; and
providing, for display via a provider transportation matching application of the provider device associated with the provider, the targeted opportunity recommendation.
